(19) United States
(12) Patent Application Publication
(10) Pub. No.: US 2021/0390430 A1
(43) Pub. Date: Dec. 16, 2021

(54) Machine Learning System and Method for Garment Recommendation

(71) Applicant: ROKKCB10, INC., Miami, FL (US)

(72) Inventor: Adriana Aristizabal, Miami, FL (US)

(21) Appl. No.: 17/303,938

(22) Filed: Jun. 10, 2021

Related U.S. Application Data
(60) Provisional application No. 62/705,124, filed on Jun. 12, 2020.

(51) Int. Cl. G06N 5/04; G06F 16/55; G06F 16/583; G06F 16/36; G06N 20/00; G06K 9/46; G06K 9/62

(52) U.S. Cl. CPC G06N 5/04; G06F 16/55; G06F 16/5838; G06F 16/367; G06K 9/6263; G06K 9/469; G06K 9/4652; G06K 9/6261; G06K 9/6267; G06N 20/00

(57) ABSTRACT

A machine learning based garment recommendation system for displaying a recommended set of garment digital images to a user comprises one or more garment sources, one or more user devices, and a garment recommendation computing device. The garment recommendation computing device is configured to determine a color palette, one or more physical characteristics, and one or more style preferences associated with the user and generate a user ranking graph. The garment recommendation computing device is further configured to assign, for each garment digital image, a plurality of category labels corresponding to one or more attributes associated with a garment and generate the recommended set of garment digital images to be displayed based on the user ranking graph and the assigned plurality of category labels using a machine learning model. At least one of the one or more user devices is configured to display the recommended set of garment digital images.

### PRIOR RELATED APPLICATIONS

This application claims priority of U.S. Application No. 62/705,124, filed Jun. 12, 2020 and incorporated by reference in its entirety for all purposes.

### BACKGROUND OF THE INVENTION

Internet sites personalize the user experience to improve engagement and to differentiate their product through high-level customization. A recommendation system improves the user's experience; resulting in increased commercial success. Today, customization is limited to personalized recommendations based on the user's tastes and preferences. System may track historical user interactions with fashion products and preferences; and utilize that past information to make recommendations.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an exemplary garment recommendation system, in accordance with some embodiments;

FIG. 2 illustrates a block diagram of an exemplary user device for use within the garment recommendation system of FIG. 1, in accordance with some embodiments;

FIG. 3 illustrates a block diagram of an exemplary garment recommendation computing device for use within the garment recommendation system of FIG. 1, in accordance with some embodiments;

FIG. 4 illustrates a block diagram of an exemplary garment recommendation computing device processor of the garment recommendation computing device of FIG. 3, in accordance with some embodiments;

FIG. 5 illustrates an exemplary ontology generated by the garment recommendation computing device of FIG. 3, in accordance with some embodiments;

FIG. 6 illustrates an exemplary taxonomy generated by the garment recommendation computing device of FIG. 3 in accordance with some embodiments;

FIGS. 7 through 9 illustrate functional block diagrams representing the operations of the garment recommendation computing device, in accordance with some embodiments;

FIG. 10 illustrates an exemplary color palette determined by the garment recommendation computing device of FIG. 3, in accordance with some embodiments;

FIG. 11 illustrates another functional block diagram representing an exemplary operation of the garment recommendation computing device, in accordance with some embodiments;

FIG. 12 illustrates an exemplary user ranking graph generated by the garment recommendation computing device of FIG. 3, in accordance with some embodiments;

FIG. 13 illustrates an exemplary method for recommending garments, in accordance with some embodiments;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one aspect, a machine learning based garment recommendation system for displaying a recommended set of garment digital images to a user comprises one or more garment sources, one or more user devices, and a garment recommendation computing device operatively coupled to the one or more garment sources and to the one or more user devices. The one or more garment sources provides one or more garment digital images. Each garment digital image has an associated garment. The one or more user devices comprises a user device transceiver for receiving communications, a user device interface for receiving one or more user inputs, and a user device display. The garment recommendation computing device comprises a user ranking unit configured to determine a color palette, one or more physical characteristics, and one or more style preferences associated with the user based on the one or more user inputs and generate a user ranking graph comprising a plurality of nodes corresponding to a plurality of predefined color palettes, physical characteristics, and style preferences. Each of the plurality of nodes is assigned a weightage based on the determined color palette, the one or more physical characteristics, and the one or more style preferences associated with the user. The garment recommendation computing device further comprises a garment categorization unit configured to assign, using an image processing unit, a plurality of category labels to each garment digital image. Each of the plurality of category labels corresponds to one or more attributes associated with a garment in the garment digital image. The garment recommendation computing device further comprises a garment recommendation unit configured to generate, using a machine learning model, the recommended set of garment digital images to be displayed. The recommended set being determined based on the user ranking graph and the assigned plurality of category labels. At least one of the one or more user devices is configured to receive from the garment recommendation computing device via the user device transceiver and display on the user device display the recommended set of garment digital images.

In another aspect, a machine learning based garment recommendation method for displaying a recommended set of garment digital images to a user in a system comprising one or more garment sources, one or more user devices, and a garment recommendation computing device is described. The method comprises receiving, from the one or more garment sources, one or more garment digital images. Each garment digital image has an associated garment. The method further comprises receiving, by a user device interface of at least one of the one or more user devices, one or more user inputs. In addition, the method comprises determining, by a user ranking unit of the garment recommendation computing device, a color palette, one or more physical characteristics, and one or more style preferences associated with the user based on the one or more user inputs. The method further comprises generating, by the user ranking unit of the garment recommendation computing device, a user ranking graph comprising a plurality of nodes corresponding to a plurality of predefined color palettes, physical characteristics, and style preferences. Each of the plurality of nodes is assigned a weightage based on the determined color palette, the one or more physical characteristics, and the one or more style preferences associated with the user. Further, the method comprises assigning, by a garment categorization unit of the garment recommendation computing device, a plurality of category labels to each garment digital image using an image processing unit. Each of the plurality of category labels corresponds to one or more attributes associated with a garment in the garment digital image. The method further comprises generating, by a garment recommendation unit of the garment recommendation computing device, the recommended set of garment digital images to be displayed. The recommended set being determined using a machine learning model based on the user ranking graph and the assigned plurality of category labels. The method further comprises receiving via a user device transceiver of the at least one of the one or more user devices and displaying on a user device display of the at least one of the one or more user devices, the recommended set of garment digital images.

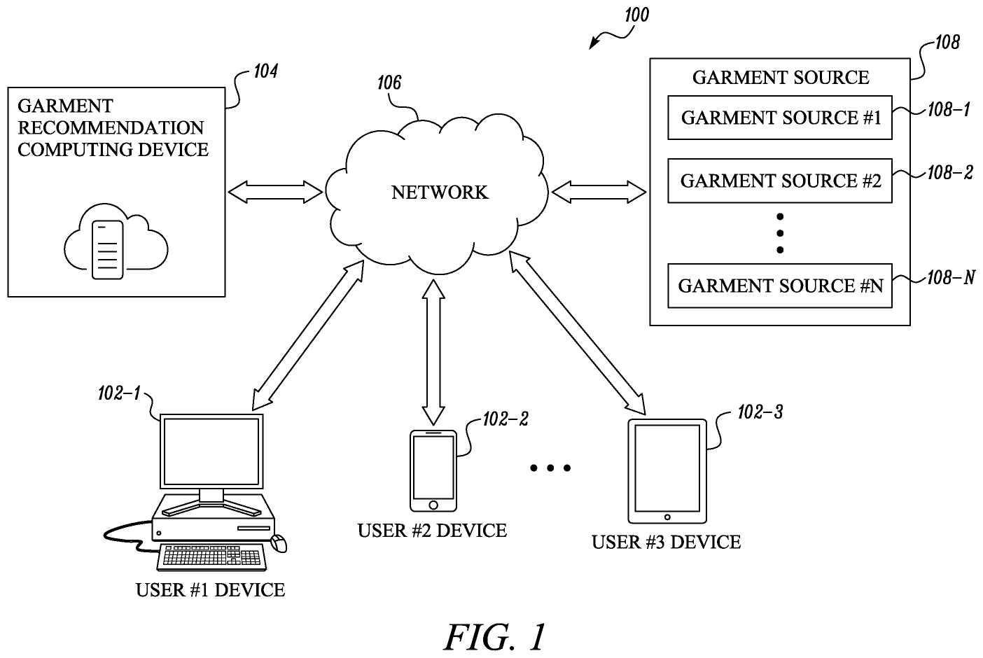

FIG. 1 is a block diagram of an exemplary machine learning based garment recommendation system 100 in accordance with some embodiments of the present disclosure. The garment recommendation system 100 is configured to display a recommended set of garment digital images including one or more garments to a user. In accordance with various embodiments, the garments may include one or more of the clothing items, such as, tops, dresses, trousers, and the like. However, it may be contemplated that the garments may also include clothing accessories, such as handbags, scarfs, and other objects, and the like. As shown, the garment recommendation system 100 includes one or more user devices 102, at least one garment recommendation computing device 104, a network 106, and one or more garment sources 108.

The garment recommendation computing device 104 may be operatively coupled to and configured to provide information to and receive information from the one or more user devices 102, and the one or more garment sources 108. Communication between the garment recommendation computing device 104 and various components of the garment recommendation system 100 can occur through the network 106. In some embodiments, the network 106 is, for example, a wide area network (WAN) (e.g., a transport control protocol/internet protocol (TCP/IP) based network), a cellular network, or a local area network (LAN) employing any of a variety of communications protocols as is well known in the art.

The one or more garment sources 108 may, for example, include one or more online vendors and/or any other garment source, herein known or are future developed. For instance, the one or more garment sources 108, such as 108-1, 108-2, . . . 108-N, may include one or more online and/or offline garment retailers or brands having their respective inventories of garments and are configured to facilitate online and/or offline purchasing and selling of one or more garments to users associated with the one or more user devices 102. In some embodiments, the one or more garment sources 108 may be updated regularly or timely to remove older garments and/or to include new garments, such as in connection with new styles, current trends, or for a new season. Each garment provided by the one or more garment sources 108 has one or more associated garment digital images that represent the garment. In some embodiments, each garment may also have an associated name and description, that may vary according to the brand of the garment, for example. In an exemplary embodiment, the name may indicate a type of the garment such as, tops, bottoms, skirt, dress, and the like and the description may indicate additional details such as, a material, a pattern, size, and the like, associated with the garment. In some additional embodiments, each garment may also have one or more associated color swatches representing the one or more colors of the garment. The one or more garment sources 108 are configured to provide data, such as, the garment digital images, the name and description, and the color swatches, for each garment to the garment recommendation computing device 104. Alternatively, in some embodiments, the garment recommendation computing device 104 may be configured to obtain this data, for example, the garment digital images, the name and description, and the color swatches, for each garment, by data scraping, from the Internet, such as by scanning and extracting information from the websites of the one or more garment sources 108. In some alternative embodiments, the garment recommendation computing device 104 may be configured to obtain the data such as, the garment digital images, the name and description, and the color swatches, for each garment from an electronic catalog provided by the one or more garment sources 108, using suitable data extraction techniques now known in the art or in the future developed.

Each of the one or more user devices 102, such as, 102-1, 102-2, 102-3, operates as an interface for a corresponding user. Each corresponding user utilizes the user device 102 to provide one or more user inputs to and receive one or more outputs from the garment recommendation computing device 104. In some embodiments, the one or more user devices 102 may include an application or website portal or any other suitable interface through which the corresponding user may communicate to and from the garment recommendation computing device 104. The user device 102 may store and communicate to the garment recommendation computing device 104 data associated with one or more of a physical characteristic, a style preference, and a feedback of the corresponding user. In accordance with various embodiments, the data associated with the physical characteristics may include, but is not limited to, one or more of a hair color, a skin color, an eye color, a weight, a height, and/or other body measurements or characteristics of the corresponding user. The data associated with the style preferences may include, but is not limited to, one or more of data or reference garment images representing various styles, such as, boho, casual, chic, minimal, and the like, preferred by the corresponding user. The data associated with the feedback of the user may include, but is not limited to, liking via a like option or right swipe option, disliking via a dislike option or a left swipe option, successful purchasing, and/or shortlisting of garments displayed to the corresponding user on the user device 102. In some embodiments, the user device 102 may also store and communicate to the garment recommendation computing device 104 a user profile of the corresponding user. The user profile may include, but is not limited to, for example, a name of the user, an age of the user, an email of the user, current and historical geographic locations of the user, past actions performed by the user, and user feedback on a recommended list of garment digital images. Each of the one or more user devices 102 is further configured to receive a recommended set of garment digital images from the garment recommendation computing device 104.

The garment recommendation computing device 104 is configured to receive the one or more user inputs from the user device 102, the data from the one or more garment sources 108; and generate the recommended set of garment digital images, for each user, based on the received one or more user inputs corresponding to the user. The garment recommendation computing device 104 will be described in greater detail hereinafter.

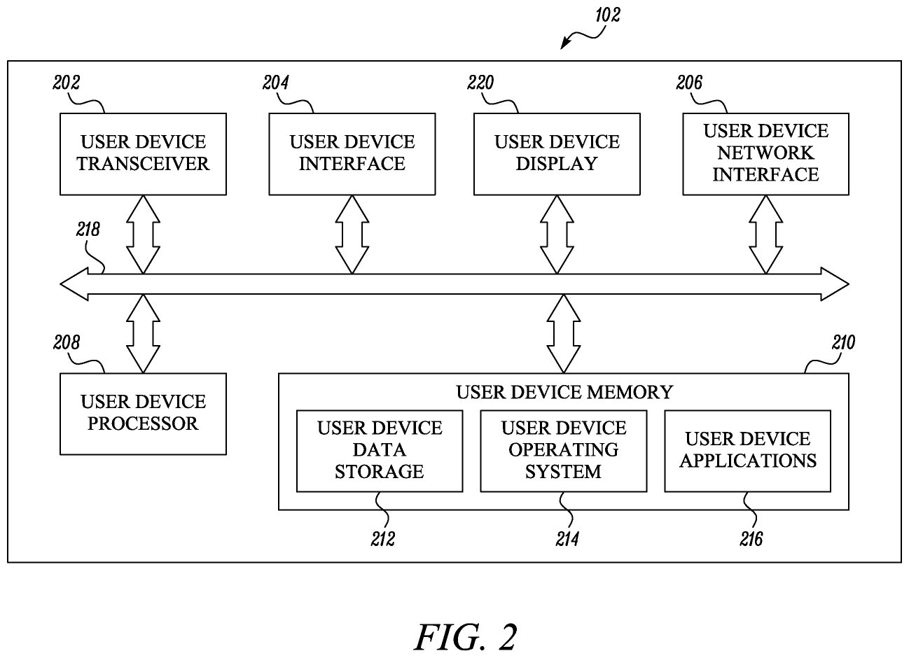

FIG. 2 is a block diagram of an exemplary user device 102 implemented within the garment recommendation system 100 of FIG. 1. The user device 102 is electrically and/or communicatively connected to a variety of other devices and databases as previously described with respect to FIG. 1 herein. In some embodiments, the user device 102 includes a plurality of electrical and electronic components, providing power, operational control, communication, and the like within the user device 102. For example, the user device 102 includes, among other things, a user device transceiver 202, a user device interface 204, a user device display 220, a user device network interface 206, a user device processor 208, and a user device memory 210.

It should be appreciated by those of ordinary skill in the art that FIG. 2 depicts the user device 102 in a simplified manner and a practical embodiment may include additional components and suitably configured logic to support known or conventional operating features that are not described in detail herein. It will further be appreciated by those of ordinary skill in the art that the user device 102 may be a personal computer, desktop computer, tablet, smartphone, or any other computing device now known or in the future developed. It will further be appreciated by those of ordinary skill in the art that the user device 102 alternatively may function within a remote server, cloud computing device, or any other remote computing mechanism now known or in the future developed.

The components of the user device 102 (for example 202, 204, 206, 208, 210, and 220) are communicatively coupled to one another via a user device local interface 218. The user device local interface 218 may be, for example but not limited to, one or more buses or other wired or wireless connections, as is known in the art. The user device local interface 218 may have additional elements, which are omitted for simplicity, such as controllers, buffers (caches), drivers, repeaters, and receivers, among many others, to enable communications. Further, the user device local interface 218 may include address, control, and/or data connections to enable appropriate communications among the aforementioned components.

The user device processor 208 is a hardware device for executing software instructions. The user device processor 208 may be any custom made or commercially available processor, a central processing unit (CPU), an auxiliary processor among several processors associated with the user device processor 208, a semiconductor-based microprocessor, or generally any device for executing software instructions. When the user device 102 is in operation, the user device processor 208 is configured to execute software stored within the user device memory 210, to communicate data to and from the user device memory 210, and to generally control operations of the user device 102 pursuant to the software instructions.

The user device 102 in the exemplary embodiment includes the user device transceiver 202 for transmitting to and receiving communications from other devices and databases in the system 100. The user device transceiver 202 incorporates within a user device transceiver antenna (not shown), enables wireless communication from the user device 102 to, for example, the garment recommendation computing device 104 and the network 106, both of FIG. 1. It will be appreciated by those of ordinary skill in the art that the user device 102 may include a single user device transceiver as shown, or alternatively separate transmitting and receiving components, for example but not limited to, a transmitter, a transmitting antenna, a receiver, and a receiving antenna. In some embodiments, the user device transceiver 202 may be configured to receive one or more questions related to the user profile of the user, one or more questions related to the physical characteristics of the user, one or more reference garment images, the recommended set of garment digital images, or an updated recommended set of garment digital images from the garment recommendation computing device 104. The user device transceiver 202 may be further configured to transmit the one or more user inputs in response to the one or more questions related to the user profile of the user, the one or more questions related to the physical characteristics, the one or more reference garment images, the recommended set of garment digital images, or the updated recommended set of garment digital images. In some embodiments, the user device transceiver 202 may be configured to transmit one or more images to the garment recommendation computing device 104. For example, the one or more images may include images of garments or images of the user.

The user device display 220 may be used to display data received from the variety of other devices and databases as previously described with respect to FIG. 1 herein. The user device display 220 may include, for example, any display screen or a computer monitor. In accordance with some embodiments, the user device display 220 is configured to display the one or more questions related to the user profile of the user, the one or more questions related to the physical characteristics of the user, the one or more reference garment images, the recommended set of garment digital images, or an updated recommended set of garment digital images, as received from the garment recommendation computing device 104 via the user device transceiver 202.

In an exemplary embodiment, the one or more questions related to the user profile of the user and the one or more questions related to the physical characteristics of the user, displayed on the user device display 220, may be in the form of one or more user selectable options, such as, but not limited to, check boxes, or drop-down menu lists, or as blank text box or a combination thereof, for the user to provide the one or more user inputs. In some embodiments, a color season quiz may be displayed, on the user device display 220, to determine a color season of the user. The color season quiz may include one or more user selectable questions related to the physical characteristics, such as the hair color, the eye color, and the skin color, of the user. For instance, a set of “x” possible eye colors, a set of “y” possible hair colors, a set of “z” possible skin color, and so on may be displayed on the user device display 220, such as in the form of drop-down menu lists or images with checkboxes for selection by the user.

In some embodiments, a body type quiz may be displayed, on the user device display 220, to determine a body type of the user. The body type quiz includes one or more user selectable questions related to the physical characteristics, such as the height, the weight, and the body dimensions of the user. In some embodiments, blank text boxes may be displayed on the user device display 220 for the user to provide the one or more user inputs associated with the height, the weight, and the body dimensions or other body type information of the user. In some other embodiments, a set of user selectable options, such as in the form of a drop-down list may be displayed on the user device display 220 for the user to provide the one or more user inputs associated with the height, the weight, and/or the body dimensions of the user. Yet, in some embodiments, a set of images corresponding to various body types may be displayed on the user device display 220 for the user to select.

Similarly, the one or more reference garment images may be displayed as user selectable options for the user to select or deselect a particular reference garment image that best suit their style or preferences. In some alternative embodiments, a style quiz may be displayed, on the user device display 220, to determine a style preferred by the user. For example, the user device display 220 may be configured to show representations of different reference garment images with different fashion styles for selection by the user. In some other examples, blank text boxes may also be displayed on the user device display 220 for the user to enter their style preferences therein.

Similarly, the recommended set of garment digital images and the updated recommended set of garment digital images may include, but is not limited to, an option for the user to like via the like option or the right swipe option, dislike via the dislike option or the left swipe option, purchase and/or shortlist each garment digital image in the recommended set and the updated recommended set displayed on the user device display 220. In some embodiments, the selectable options such as, check boxes, drop-down menu lists, etc., are also displayed on the user device display 220 for the user to indicate the body parts that the user wishes to show off or conceal. In some embodiments, the name and description, the price information, and other information associated with the garment digital image are also displayed along the garment digital images in the recommended set.

The user device interface 204 may be used to receive user input from and/or for providing system output to the user or to one or more devices or components. User input may be provided via, for example, a keyboard, a camera, touch pad, and/or a mouse. System output may be provided via a display device, such as the user device display 220, speakers, and/or a printer (not shown). The user device interface 204 may further include, for example, a serial port, a parallel port, an infrared (IR) interface, a universal serial bus (USB) interface and/or any other interface herein known or in the future developed. In accordance with some embodiments, the user device interface 204 may be configured to receive the one or more user inputs in response to the one or more questions related to the user profile of the user, the one or more questions related to the physical characteristics, the one or more reference garment images, the recommended set of garment digital images, or the updated recommended set of garment digital images displayed on the user device display 220. In some embodiments, the user device interface 204 may be configured to receive the one or more user inputs indicating the body parts that the user wishes to show off or conceal. In some embodiments, the user device interface 204 may be configured to receive the one or more images from the user. In some embodiments, the one or more images may be captured by the camera of the user device 102. In such exemplary embodiments, the one or more user inputs in response to the one or more questions related to the physical characteristics, such as, the eye color, the hair color, and the skin color of the user may include uploading an image of the user.

The user device network interface 206 may be used to enable the user device 102 to communicate on a network, such as the network 106 of FIG.1, such as, but not limited to, a wireless access network (WAN), a radio frequency (RF) network, and the like. The user device network interface 206 may include, for example, an Ethernet card or adapter or a wireless local area network (WLAN) card or adapter. Additionally, or alternatively the user device network interface 206 may include a radio frequency interface for wide area communications such as Long Term Evolution (LTE) networks, or any other network now known or in the future developed. The user device network interface 206 may include address, control, and/or data connections to enable appropriate communications on the network.

The user device memory 210 may include any of volatile memory elements (e.g., random access memory (RAM), nonvolatile memory elements (e.g., ROM), and combinations thereof. Moreover, the user device memory 210 may incorporate electronic, magnetic, optical, and/or other types of storage media. Note that the user device memory 210 may have a distributed architecture, where various components are situated remotely from one another, but can be accessed by the user device processor 208. The software in the user device memory 210 may include one or more software programs, each of which includes an ordered listing of executable instructions for implementing logical functions. The software in the user device memory 210 includes a suitable user device operating system 214 and one or more user device applications 216. The user device operating system 214 controls the execution of other computer programs, such as the one or more user device applications 216, and provides scheduling, input-output control, file and data management, memory management, and communication control and related services. The one or more user device applications 216 may be configured to implement at least some of the various processes, algorithms, methods, techniques, and the like described herein.

The user device memory 210 further includes a user device data storage 212 used to store data. In the exemplary embodiment of FIG. 2, the user device data storage 212 is located internal to the user device memory 210 of the user device 102. Additionally, or alternatively, the user device data storage 212 may be located external to the user device 102, for example, as an external hard drive connected to the user device interface 204. In a further embodiment, the user device data storage 212 may be located external and connected to the user device 102 through a network and accessed via the user device network interface 206, for example, as a cloud storage.

In some embodiments, initial information for storage in the user device data storage 212 is entered via the user device interface 204. For example, the user profile, the one or more user inputs in response to the one or more questions related to the user profile of the user, the one or more user inputs in response to the one or more questions related to the physical characteristics of the user, the one or more reference garment images, the recommended set of garment digital images, or the updated recommended set of garment digital images may be stored in the user device data storage 212.

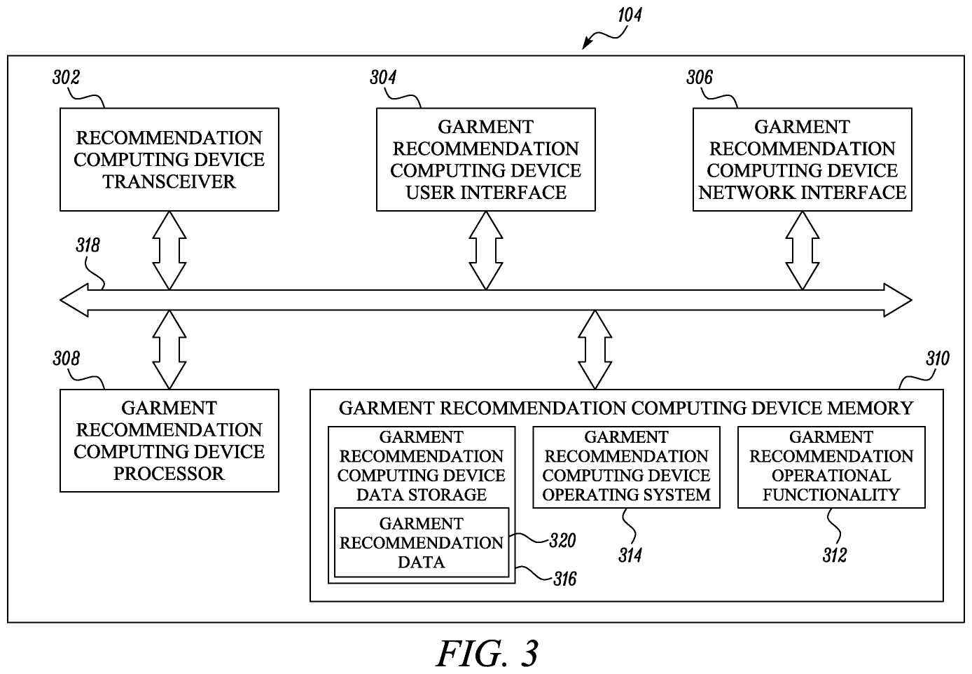

FIG. 3 is a block diagram of an exemplary garment recommendation computing device 104 implemented within the garment recommendation system 100 of FIG. 1. For example, the garment recommendation computing device 104 may be configured to implement the various methods described herein.

The garment recommendation computing device 104 is electrically and/or communicatively connected to a variety of other devices and databases as previously described with respect to FIG. 1 herein. In some embodiments, the garment recommendation computing device 104 includes a plurality of electrical and electronic components, providing power, operational control, communication, and the like within the garment recommendation computing device 104. For example, the garment recommendation computing device 104 includes, among other things, a garment recommendation computing device transceiver 302, a garment recommendation computing device user interface 304, a garment recommendation computing device network interface 306, a garment recommendation computing device processor 308, and a garment recommendation computing device memory 310.

It should be appreciated by those of ordinary skill in the art that FIG. 3 depicts the garment recommendation computing device 104 in a simplified manner and a practical embodiment may include additional components and suitably configured logic to support known or conventional operating features that are not described in detail herein. It will further be appreciated by those of ordinary skill in the art that the garment recommendation computing device 104 may be a personal computer, desktop computer, tablet, smartphone, or any other computing device now known or in the future developed.

It will further be appreciated by those of ordinary skill in the art that the garment recommendation computing device 104 alternatively may function within a remote server, cloud computing device, or any other remote computing mechanism now known or in the future developed. For example, the garment recommendation computing device 104 in some embodiments may be a cloud environment incorporating the operations of the garment recommendation computing device processor 308, the garment recommendation computing device memory 310, the garment recommendation computing device user interface 304, and various other operating modules to serve as a software as a service model for the user devices 102.

The components of the garment recommendation computing device 104 (for example 302, 304, 306, 308, and 310) are communicatively coupled to one another via a garment recommendation computing device local interface 318. The garment recommendation computing device local interface 318 may be, for example but not limited to, one or more buses or other wired or wireless connections, as is known in the art. The garment recommendation computing device local interface 318 may have additional elements, which are omitted for simplicity, such as controllers, buffers (caches), drivers, repeaters, and receivers, among many others, to enable communications. Further, the garment recommendation computing device local interface 318 may include address, control, and/or data connections to enable appropriate communications among the aforementioned components.

The garment recommendation computing device processor 308 is a hardware device for executing software instructions. The garment recommendation computing device processor 308 may be any custom made or commercially available processor, a central processing unit (CPU), an auxiliary processor among several processors associated with the garment recommendation computing device processor 308, a semiconductor-based microprocessor, or generally any device for executing software instructions. When the garment recommendation computing device 104 is in operation, the garment recommendation computing device processor 308 is configured to execute software stored within the garment recommendation computing device memory 310, to communicate data to and from the garment recommendation computing device memory 310, and to generally control operations of the garment recommendation computing device 104 pursuant to the software instructions.

The garment recommendation computing device user interface 304 may be used to receive user input from and/or for providing system output to the user or to one or more devices or components. User input may be provided via, for example, a keyboard, touch pad, and/or a mouse. System output may be provided via a display device, speakers, and/or a printer (not shown). The garment recommendation computing device user interface 304 may further include, for example, a serial port, a parallel port, an infrared (IR) interface, a universal serial bus (USB) interface and/or any other interface herein known or in the future developed.

The garment recommendation computing device network interface 306 may be used to enable the garment recommendation computing device 104 to communicate on a network, such as the network 106 of FIG.1, a wireless access network (WAN), a radio frequency (RF) network, and the like. The garment recommendation computing device network interface 306 may include, for example, an Ethernet card or adapter or a wireless local area network (WLAN) card or adapter. Additionally or alternatively, the garment recommendation computing device network interface 306 may include a radio frequency interface for wide area communications such as Long Term Evolution (LTE) networks, or any other network now known or in the future developed. The garment recommendation computing device network interface 306 may include address, control, and/or data connections to enable appropriate communications on the network.

The garment recommendation computing device memory 310 may include any of volatile memory elements (e.g., random access memory (RAM), nonvolatile memory elements (e.g., ROM), and combinations thereof. Moreover, the garment recommendation computing device memory 310 may incorporate electronic, magnetic, optical, and/or other types of storage media. Note that the garment recommendation computing device memory 310 may have a distributed architecture, where various components are situated remotely from one another, but can be accessed by the garment recommendation computing device processor 308. The software in the garment recommendation computing device memory 310 may include one or more software programs, each of which includes an ordered listing of executable instructions for implementing logical functions. The software in the garment recommendation computing device memory 310 includes a suitable garment recommendation computing device operating system 314 and garment recommendation operational functionality 312. The garment recommendation computing device operating system 314 controls the execution of other computer programs, such as the garment recommendation operational functionality 312, and provides scheduling, input-output control, file and data management, memory management, and communication control and related services. The garment recommendation operational functionality 312 may be configured to implement at least some of the various processes, algorithms, methods, techniques, and the like described herein.

The garment recommendation computing device memory 310 further includes a garment recommendation computing device data storage 316 used to store data. In the exemplary embodiment of FIG. 3, the garment recommendation computing device data storage 316 is located internal to the garment recommendation computing device memory 310 of the garment recommendation computing device 104. Additionally or alternatively, (not shown) the garment recommendation computing device data storage 316 may be located external to the garment recommendation computing device 104, for example, as an external hard drive connected to the garment recommendation computing device user interface 304. In a further embodiment, (not shown) the garment recommendation computing device data storage 316 may be located external and connected to the garment recommendation computing device 104 through a network and accessed via the garment recommendation computing device network interface 306.

The garment recommendation computing device data storage 316, in accordance with some embodiments, stores garment recommendation data 320 for operational use in the various processes, algorithms, methods, techniques, and the like described herein. In some embodiments, the garment recommendation data 320 also include one or more machine learning models to perform the one or more predetermined operations, as described herein. In accordance with some embodiments, the garment recommendation data 320 may include the data such as, the garment digital images, the name and description, and the color swatches, for each garment obtained from the one or more garment sources 108. In some embodiments, the garment recommendation data 320 may include a plurality of category labels assigned to each garment digital image. The category labels correspond to one or more attributes including, but not limited to, one or more of a color, a body type, a style, a neckline type, a sleeve length, a sleeve type, a print pattern, embellishment details, a fit, an occasion, a weather, and the like, associated with the garment in the respective garment digital image. In some embodiments, the garment recommendation data 320 may also include the one or more attributes stored in an indexed form for each garment in the garment digital images. In some embodiments, the garment recommendation data 320 may also include size measurement information, such as waist size measurements, shoulder width measurements, length measurements and the like, of various types of garments from various brands corresponding to each size, such as, small, medium, large, extra-large sizes provided by the brands.

In accordance with some embodiments, the garment recommendation data 320 may include a dictionary defining a number of terms that are formally or commonly used to represent different aspects of various garments known within the fashion industry. For example, the terms may include, but are not limited to, casual, high rise, long sleeves, cowl neck, tank top, cold shoulder, boho, A-line, and other such terms representing different aspects associated with the garments, as predefined or known within the fashion industry. In some embodiments, the terms in the dictionary may be updated periodically to include new terms, such as in connection with new styles, current trends, or for a new season. In accordance with some embodiments, the garment recommendation data 320 may further include an ontology for formally structuring and organizing these terms within the dictionary, a taxonomy based on the ontology, and a user ranking graph based on the taxonomy, which will all be described in greater detail hereinafter.

In accordance with some embodiments, the garment recommendation data 320 may further include a plurality of prestored style vectors corresponding to a plurality of predefined styles of garments and/or various parts of the garment. Each of the prestored style vectors corresponding to the plurality of predefined styles of garments represents a numeric score indicating a particular style, such as, casual, boho, and the like, of a garment. Similarly, each of the prestored style vectors corresponding to the plurality of predefined styles of the various parts of the garment represents a numeric score indicating a particular style of each part, such as, V-neck, long sleeve, and the like, of the garment. In some embodiments, the garment recommendation data 320 may also include data associated with the users of the one or more user devices 102. For example, the garment recommendation data 320 may include one or more of a color season, a color season palette, a color sub-season, a color sub-season palette, the physical characteristics, the style preferences, the feedback, and the user profile associated with each user.

The garment recommendation computing device 104 in the illustrated example includes the garment recommendation computing device transceiver 302. The garment recommendation computing device transceiver 302 incorporates within a garment recommendation computing device transceiver antenna (not shown), enables wireless communication from the garment recommendation computing device 104 to, for example, the one or more user devices 102 and the network 106, both of FIG. 1. It will be appreciated by those of ordinary skill in the art that the garment recommendation computing device 104 may include a single garment recommendation computing device transceiver as shown, or alternatively separate transmitting and receiving components, for example but not limited to, a transmitter, a transmitting antenna, a receiver, and a receiving antenna.

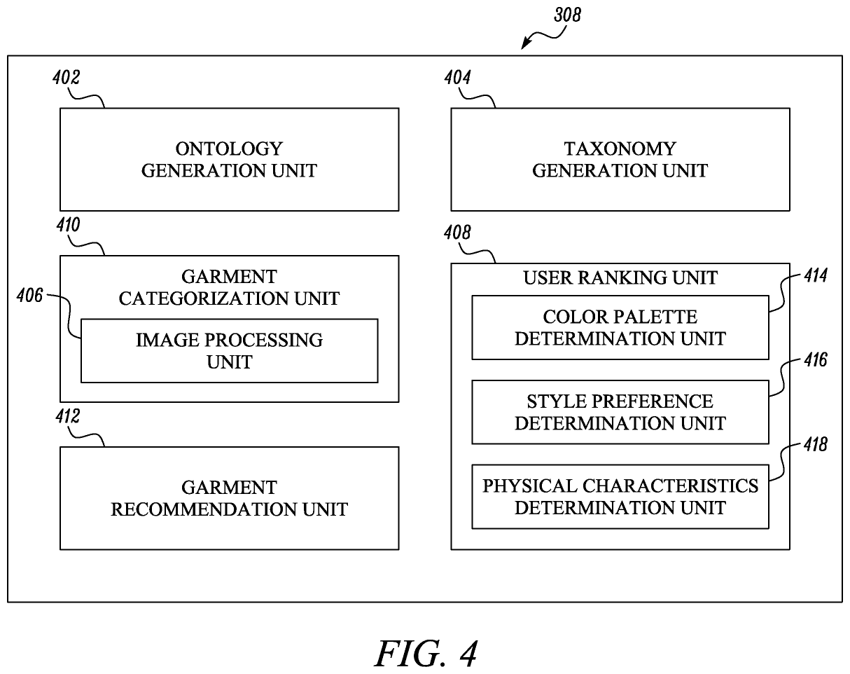

FIG. 4 is a block diagram of a garment recommendation computing device processor 308 of the garment recommendation computing device 104 in accordance with some embodiments. As illustrated, the garment recommendation computing device processor 308 includes an ontology generation unit 402, a taxonomy generation unit 404, a user ranking unit 408, a garment categorization unit 410, and a garment recommendation unit 412. However, it may be contemplated that the garment recommendation computing device processor 308 may also include additional components that are not described herein for the sake of brevity.

The ontology generation unit 402 is configured to obtain the plurality of terms stored in the dictionary of the garment recommendation computing device data storage 316 and generate an ontology based on the plurality of terms. The ontology generation unit 402 may be configured to use any ontology generation methodology, known in the art, to generate the ontology. For example, the ontology generation unit 402 is configured to generate the ontology by identifying the related terms in the plurality of terms and grouping them under different categories. Further, the ontology generation unit 402 is configured to define relationships between different categories in the generated ontology. The ontology provides definition to the plurality of terms and defines one or more relationships between the plurality of terms in a structured manner. For instance, the ontology may represent formalized structuring of the information associated with the fashion industry to effectively categorize the various concepts and terms known in the industry and associate the garments more effectively with these concepts and terms within the ontology. In accordance with various embodiments, the ontology generation unit 402 is configured to periodically determine whether any new terms are included in the dictionary and update the generated ontology to include the new terms. In some embodiments, the ontology generation unit 402 is configured to store the generated and updated ontology in the garment recommendation computing device data storage 316.

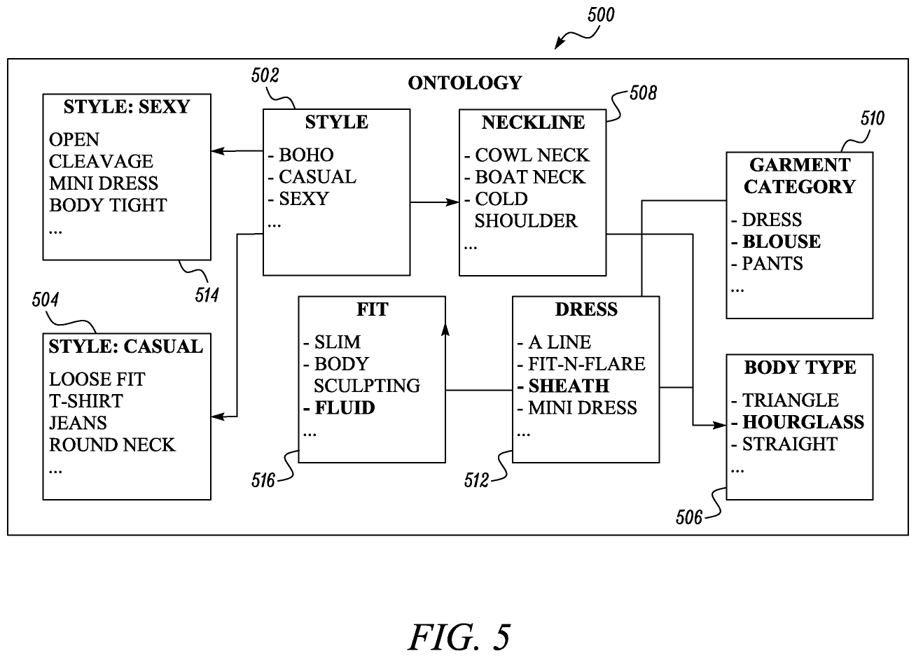

For instance, FIG. 5 illustrates an exemplary ontology 500 generated by the ontology generation unit 402. The ontology 500 provides the garment recommendation computing device 104 with an efficient manner to define the plurality of terms in the dictionary and describe how individual terms are related to one another. For example, the terms “casual” and “boho” in the dictionary may be defined and classified as belonging to a “style” category 502 in the ontology 500. Thus, a “casual” category 504 may be structured as being a subset of the “style” category 502 and may include the terms, such as, loose-fit, jeans, round neck, and the like Further, a “sexy” category 514 may include the terms, such as, open cleavage, mini dress, body tight, and the like, and may be structured as being a subset of the “style” category 502. Similarly, a “body type” category 506 may include sub-categories such as, but not limited to, triangle, hourglass, straight and these sub-categories may be linked to different style categories 502, neckline categories 508, garment categories 510 and so on, as illustrated. Further, a “dress” category 512 may include sub-categories such as, but not limited to, A-line, fit-n-flare, sheath, and mini dress and may be structured as being a subset of a “garment category” category 510. The “dress” category 512 may be further linked to a “fit” category 516 including the terms, such as, slim, body sculpting, fluid, and the like It may be contemplated that the illustrated ontology is merely exemplary and may be varied as per requirement to achieve similar results without deviating from the scope of the claimed subject matter.

Referring back to FIG. 4, the taxonomy generation unit 404 is configured to obtain the stored ontology, such as the ontology 500, from the garment recommendation computing device data storage 316 and generate the taxonomy by classifying the plurality of terms in the generated ontology in a hierarchical order based on the characteristics of the plurality of terms. The generated taxonomy includes the plurality of nodes representing the plurality of terms arranged in the hierarchical order and the relationship between the plurality of nodes. In accordance with various embodiments, the taxonomy generation unit 404 is configured to periodically determine whether the ontology stored in the garment recommendation computing device data storage 316 is updated and update the generated taxonomy based on the updated ontology. In some embodiments, the taxonomy generation unit 404 is configured to store the generated and updated taxonomy in the garment recommendation computing device data storage 316.

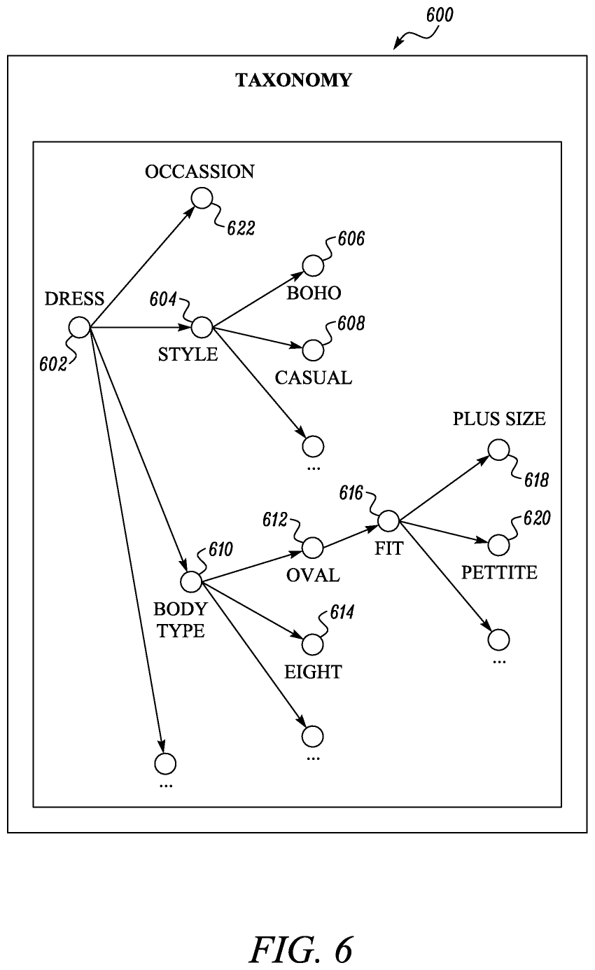

For instance, FIG. 6 illustrates an exemplary taxonomy 600 generated by the taxonomy generation unit 404. The taxonomy 600 provides the garment recommendation computing device 104 with a logical structure that uses hierarchies to classify the terms and their relationships defined in the ontology based on their shared characteristics. For example, in the taxonomy 600, a node 602 representing a “dress” is linked to nodes 606, 608 representing “boho” and “casual” in a hierarchical manner via a node 604 representing a “style”. Similarly, the nodes 610, 622 representing “body type” and “occasion”, respectively are also linked to the node 602 representing the “dress”. Further, nodes 612, 614 representing “oval” and “eight” body types, respectively are linked to the node 610 representing the “body type”. Similarly, nodes 618, 620 representing “plus size” and “petite”, respectively, are linked to the node 612 representing the “oval” via a node 616 representing “fit”. It may be contemplated that the illustrated taxonomy is merely exemplary and may be varied as per requirement to achieve similar results without deviating from the scope of the claimed subject matter.

Referring again back to FIG. 4, the garment categorization unit 410 is configured to obtain the data such as, the garment digital images, the name and description, and the color swatches for each garment from the one or more garment sources 108. The garment categorization unit 410 is configured to assign a plurality of category labels to each garment digital image received from the one or more garment sources 108. The category labels correspond to one or more attributes associated with a garment in the garment digital image. As described above, the one or more attributes associated with the garment may include, but is not limited to, one or more of the color, the body type, the style, the neckline type, the sleeve length, the sleeve type, the print pattern, the embellishment details, the fit, and so on. These attributes are categorized by their visual effect on the body. Then, those categories can be combined in a model to create results including a final score that will result in a better recommendation according to the body type of the user. In some embodiments, the garment categorization unit 410 may be configured to index and store all the information, including the one or more attributes, associated with each garment in the garment digital images in the garment recommendation computing device data storage 316 as the garment recommendation data 320.

The category labelling enables the garment recommendation computing device 104 to present the user with garment recommendations that best match the user characteristics and personal dressing preferences. In some embodiments, the garment categorization unit 410 is configured to periodically determine whether any new garments are included in the one or more garment sources 108 and obtain the data associated with the new garments and assign category labels to the newly added garments in a similar manner. The garment categorization unit 410 is further configured to store the obtained data in the garment recommendation computing device data storage 316. In accordance with various embodiments, the category labels assigned to the garment digital images may also be verified and updated by the fashion consulting experts.

In accordance with some embodiments, the garment categorization unit 410 utilizes the ontology 500, and the hierarchical order defined in the taxonomy 600, to assign the category labels to the garment digital images. For example, each garment digital image is analyzed to be assigned the category labels across all applicable nodes defined in the taxonomy 600.

As shown in FIG. 4, the garment categorization unit 410 may also include an image processing unit 406 and may be configured to assign the plurality of category labels to the garment digital images using the image processing unit 406. In accordance with various embodiments, the image processing unit 406 is configured to electronically processes the garment digital image and other data, such as the name and description, the color swatches and the like, associated with the garment digital image to assign the plurality of category labels to the garment digital images. In an exemplary embodiment, the category labels may be further classified as color labels and semantic labels. For example, the color labels may represent the category label corresponding to one or more garment colors present in the garment digital image and the semantic labels may represent the category label corresponding to other attributes such as, the style, the pattern, the neckline type, the sleeve length, and the like associated with the garment in the garment digital image. In an exemplary implementation, the image processing unit 406 may be configured to determine the color labels based on the color swatch provided by the one or more garment sources 108 or by extracting the dominant colors of the garment from the garment digital image using various color clustering techniques. The image processing unit 406 may be configured to segment the garment in the garment digital image into one or more segments and determine the semantic labels from the one or more segments of the garment in the garment digital image. Similarly, the image processing unit 406 may be configured to segment the description in the garment digital image into one or more description segments and determine the semantic labels from the one or more description segments.

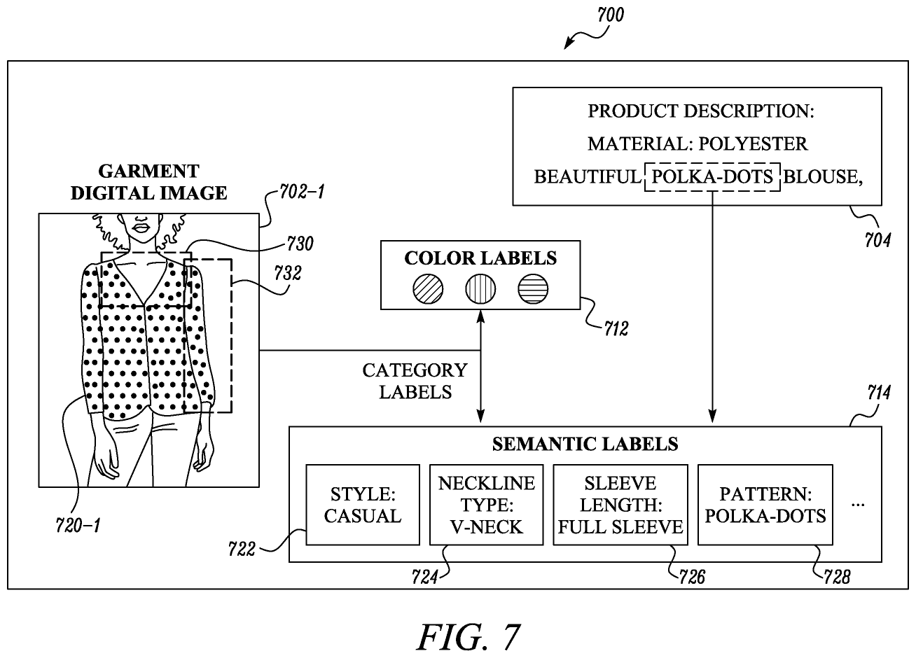

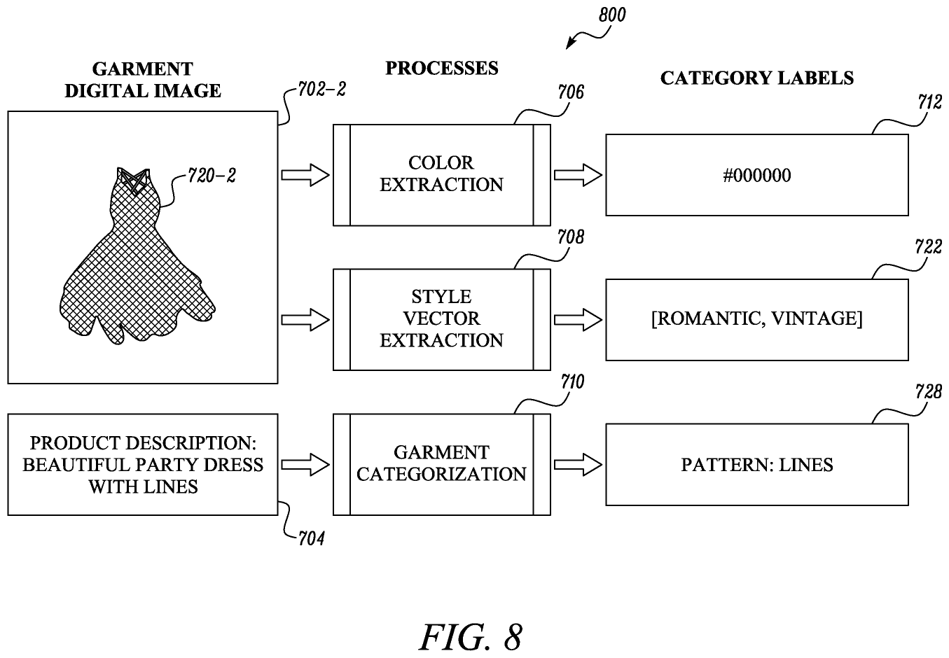

In exemplary implementations 700 and 800, as shown in respective FIGS. 7 and 8, the image processing unit 406 may be configured to extract a category label corresponding to the one or more garment colors, such as the color label 712, by applying a color extraction process 706 (as shown in FIG. 8) on the garment digital image 702 (702-1, 702-2). For example, as explained previously, the image processing unit 406 may be configured to extract the color label 712 using a color swatch provided by the one or more garment sources 108. Alternatively, when there is no color swatch provided, the image processing unit 406 may be configured to extract the color label 712 by analyzing the garment digital image 702 (702-1, 702-2), using various known color clustering techniques, to extract dominant colors in the garment digital image 702 (702-1, 702-2).

In accordance with some embodiments, the image processing unit 406 may be configured to extract the color label 712 corresponding to the one or more garment colors using the color clustering techniques and compare the extracted one or more garment colors with one or more colors in the color swatch provided by the one or more garment sources 108 to determine whether the extracted one or more garment colors correspond to the one or more colors in the color swatch. The image processing unit 406 may be configured to determine that the one or more colors in the color swatch does not represent the correct garment color, when the extracted one or more garment colors do not correspond to the one or more colors in the color swatch. The image processing unit 406 may be configured to revise and modify the color swatches provided by the one or more garment sources 108 to correspond to the extracted one or more garment colors, when the one or more colors in the color swatch are determined as not representing the correct garment color.

In accordance with some embodiments, the garment categorization unit 410 is configured to classify each garment 720 (720-1, 720-2) into one of four color seasons: Winter, Spring, Summer, Autumn, based on the color label 712 corresponding to the one or more garment colors. For example, the garments with the color labels 712 corresponding to bold and bright colors, such as, but not limited to, emerald-green, cobalt blue, holly berry red may be classified as “Winter” color season. Similarly, the garments with the color labels 712 corresponding to warm colors, such as, but not limited to, warm green, yellow, orangey red, and the like, may be classified as “Spring” color season. Similarly, the garments with the color labels 712 corresponding to cool colors, such as, but not limited to, blue, cool pinks, and the like, may be classified as “Summer” color season. Further, the garments with the color labels 712 corresponding to colors, such as, but not limited to, rust red, mustard yellow, olive green, and the like, may be classified as “Autumn” color season. In yet some additional embodiments, the garment categorization unit 410 may be further configured to classify each garment 720 (720-1, 720-2) into sub-seasons of the color seasons. For example, the garment categorization unit 410 may be configured to utilize a decision tree or any other methods known in the art to determine the color season and the sub-season of each garment 720 (720-1, 720-2) based on the determined color label 712 corresponding to the one or more colors of the garment 720 (720-1, 720-2).

The image processing unit 406 may be configured to determine the category label corresponding to the one or more styles associated with the garment 720 (720-1, 720-2) based on the comparison of a style vector of the garment 720 (720-1, 720-2) with the plurality of prestored style vectors. In an exemplary embodiment, the image processing unit 406 may be configured to extract the category label corresponding to the one or more styles of the garment, for example, the semantic label 714 corresponding to the one or more style 722 of the garment 720, using a style vector extraction process 708 (as shown in FIG. 8). For example, the image processing unit 406 may be configured to process the garment digital image 702 to determine the style vector of the garment 720 in the garment digital image 702. In an exemplary embodiment, the style vector represents a numeric score indicating one or more styles of the garment 720. The image processing unit 406 is further configured to obtain the plurality of prestored style vectors corresponding to the plurality of predefined styles from the garment recommendation computing device memory 310 and compare the style vector of the garment with the plurality of prestored style vectors. The image processing unit 406 is further configured to determine the semantic label 714 corresponding to the one or more styles 722 of the garment 720 based on the comparison of the style vector of the garment 720 with the plurality of prestored style vectors. In one embodiment, the image processing unit 406 may be configured to use curated reference garment images representing various styles taken from internet sites and a vector representation of similarity for a plurality of classes to determine the semantic label 714 corresponding to the one or more style 722 of the garment 720.

The image processing unit 406 may be configured to first segment the garment digital image 702 (702-1, 702-2) to determine the position of each garment 720 (720-1, 720-2) in the garment digital image 702 (702-1, 702-2). In some embodiments, the image processing unit 406 may be further configured to determine whether the garment digital image contains an image of the entire garment 720 (720-1, 720-2) when the position of the garment is determined. The image processing unit 406 may be further configured to determine the style vector of the garment 720 (720-1, 720-2) when the garment digital image 702 (702-1, 702-2) contains the image of the entire garment 720 (720-1, 720-2). In some embodiments, the style vector may be extracted using Deep Neural Networks. In some embodiments, a model employing the Deep Neural Networks may be trained using reference garment images representing various styles provided and tagged by experts in fashion.

In an exemplary implementation, the image processing unit 406 may be configured to utilize a machine learning model to extract the one or more attributes from the reference style image to classify any garment by style. It will be appreciated by those of ordinary skill in the art that the machine learning model may utilize a convolutional neural network (CNN). In accordance with some embodiments of the invention, the machine learning model may utilize any machine learning methodology, now known or in the future developed, for classification. For example, the machine learning methodology utilized may be one or a combination of: Linear Classifiers (Logistic Regression, Naive Bayes Classifier); Nearest Neighbor; Support Vector Machines; Decision Trees; Boosted Trees; Random Forest; and/or Neural Networks.

The image processing unit 406 may be configured to extract the category label, for example, the semantic label 714 corresponding to other attributes, for example, the print pattern 728 like polka dots, vertical lines, and the like, on the garment 720 (720-1, 720-2), using a garment categorization process 710 (as shown in FIG. 8). For example, the image processing unit 406 may be configured to extract the semantic label 714 corresponding to the pattern 728 of the garment 720 (720-1, 720-2) in the garment digital image 702 (702-1, 702-2) by segmenting and processing the text provided in the name and description 704 associated with the garment digital image 702. For example, the image processing unit 406 may be configured to parse and process the text provided in the name and description 704 using various known Natural Language Processing (NLP) techniques, to determine the semantic labels 714. In some embodiments, the names and descriptions may vary according to the brand and the individual garment retailers, therefore the image processing unit 406 may be configured to first apply normalization to the text associated with the names and descriptions prior to parsing the text. It will be appreciated that when the name and description 704 associated with the garment digital image 702 (702-1, 702-2) specifies other attributes such as the neckline type, the material, the occasion, the weather, and the like, of the garment 720, the image processing unit 406 may be configured to extract all possible semantic labels 714 from the name and description 704 of the garment 720 in the garment digital image 702.

In accordance with some embodiments, as shown in FIG. 7, the image processing unit 406 is configured to segment the garment 720 in the garment digital image 702 to one or more garment segments, such as garment segments 730, 732 and determine the one or more attributes, such as, the neckline type 724, the sleeve length 726, and the like, associated with these garment segments 730, 732. The image processing unit 406 may then be configured to determine the semantic labels 714 corresponding to the attributes associated with the garment segments 730, 732. In an embodiment, the image processing unit 406 may be configured to determine the semantic labels 714 corresponding to the neckline type 724 of the garment 720 by processing the garment segment 730. Thus, in the illustrated example, the neckline type 724 is determined to be V-neck for the garment 720-1 in the garment digital image 702-1. Similarly, the image processing unit 406 may be configured to determine the semantic labels 714 corresponding to the sleeve length 726 of the garment 720 by processing the garment segment 732. Thus, in the illustrated example, the sleeve length 726 is determined to be “long sleeve” for the garment 720-1 in the garment digital image 702-1. In accordance with various embodiments, the image processing unit 406 may be configured to utilize the style vector extraction process, as described above, to determine the semantic labels 714 based on the one or more garment segments 730, 732.

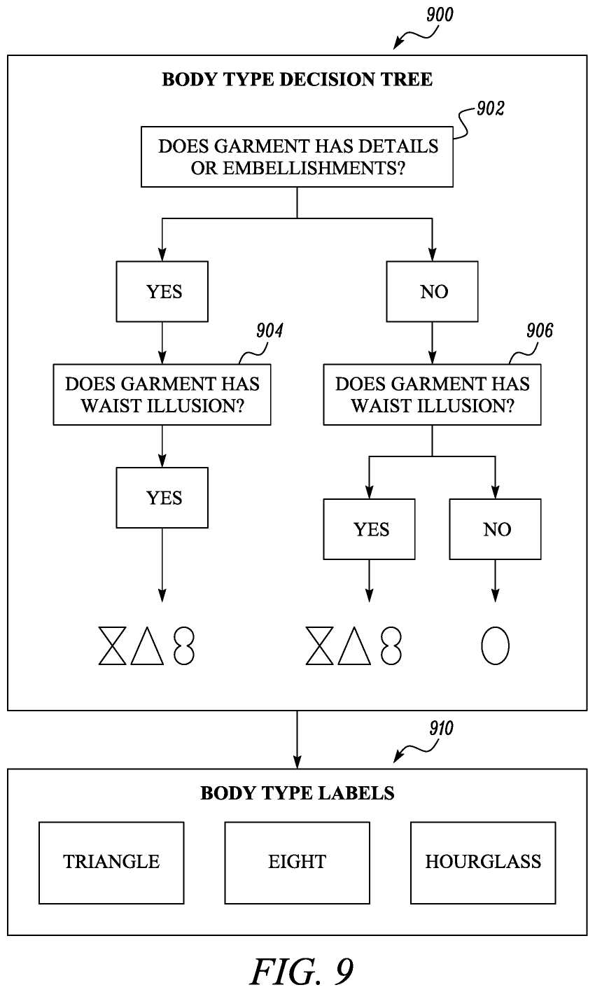

In accordance with some embodiments, the garment categorization unit 410 may be configured to determine a category label 910 (as shown in FIG. 9), corresponding to a body type associated with the garment based on the determined one or more attributes. The garment categorization unit 410 may be configured to determine the category label 910 corresponding to the body type associated with the garment based on the determined color labels and the semantic labels corresponding to the various attributes associated with the garment. The garment categorization unit 410 maps each garment to one or more body types that will work best for a particular garment. For instance, the garment categorization unit 410 may determine the body type by performing illusion dressing using NLP and a domain specific body type decision tree 900 stored in the garment recommendation computing device data storage 316, as described below. In accordance with some embodiments, the garment categorization unit 410 may be configured to use the types of sleeves, neckline, fit, length and material for the tops and the leg shape, hem, rise, fit, length for the bottoms to determine which features are negative or positive to each body type of individuals. The garment categorization unit 410 may be configured to decide according to the combination of features if the garment should be associated with a particular body type or not. In some embodiments, the garment categorization unit 410 may be configured to map each garment to a body type in real time with inclusion of new garments.

The color labels and the semantic labels corresponding to the pattern, the fit, the embellishments, the waist illusions, and the like, may be used to determine the category label 910 corresponding to the body type (shown as body type labels 910 in FIG. 9) associated with the garment in the respective garment digital image. Generally, the domain-specific body type decision tree may represent a set of predefined rules that determine a further level of labeling based on the color labels and the semantic labels extracted from the garment digital images and the associated name and description. The decision tree may be used to determine the body types that best apply to the garment in the garment digital image.

For the purposes of explanation, a simplified decision tree 900 is illustrated in FIG. 9. At step 902 of the decision tree 900, the garment may be scanned to detect presence of embellishments therein. The garment may further be evaluated on presence of waist illusion (step 904 and 906). When the garment has embellishments and waist illusion, then it may be associated with “triangle”, “hourglass” and “eight” body types. When the garment does not have embellishments but has waist illusion, then it may be associated with “triangle”, “hourglass” and “eight” body types. Similarly, when the garment does not have embellishments and also does not have waist illusion, then it may be associated with “oval” body type. It may be contemplated by those ordinarily skilled that the decision tree 900 and the body types are merely exemplary and are not to be construed as limiting the scope of the claimed subject matter.

All the data associated with the garment 720 within each of the garment digital image 702, such as the color labels, semantic labels, body type labels, and so on, may be stored within the garment recommendation computing device data storage 316 as garment recommendation data 320.

Referring back to FIG. 4, the user ranking unit 408 may be configured to generate a user ranking graph for every user interacting with the system 100. The user ranking graph may include a plurality of nodes corresponding to a plurality of predefined color palettes, physical characteristics, and style preferences. The plurality of predefined color palettes, physical characteristics, and style preferences may be determined based on the generated taxonomy, such as the taxonomy 600 of FIG. 6. For example, the user ranking unit 408 is configured to generate the user ranking graph by assigning weightages to the plurality of nodes defined in the taxonomy. In accordance with various embodiments, the weightages assigned to each of the plurality of nodes represent the relevance of the corresponding node with regard to the user and their preferences to generate a weighted user ranking graph specific to the user.

In an embodiment of the present disclosure, the user ranking unit 408 is configured to determine a color palette, the one or more physical characteristics, and the one or more style preferences associated with the user based on the one or more user inputs received from the corresponding user device 102. The user ranking unit 408 is further configured to assign the weightages to the plurality of nodes defined in the taxonomy based on the determined color palette, the one or more physical characteristics, and the one or more style preferences associated with the user. In some embodiments, the weightages assigned to each node may also be determined or updated based on the user feedback corresponding to the recommended set of garment digital images displayed to the user on the user device display 220.

As illustrated in FIG.4, the user ranking unit 408 includes a color palette determination unit 414, a style preference determination unit 416, and a physical characteristics determination unit 418 to determine the color palette, the one or more style preferences, and the one or more physical characteristics, respectively, associated with the user. The color palette determination unit 414 may be configured to receive the data, such as the hair color, the eye color, and the skin color from the one or more user inputs received from the user and accordingly determine a color season and color sub-season associated with the user.

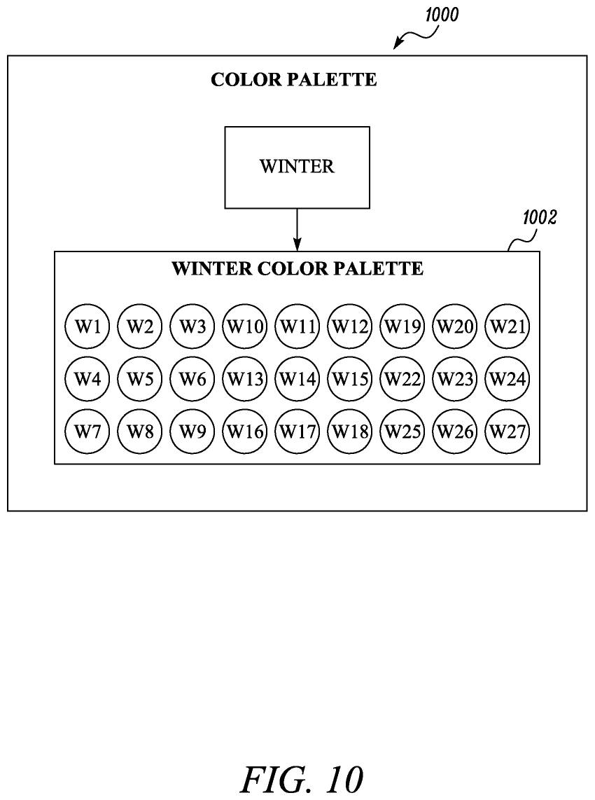

It will be appreciated that the color season is a color model defined upon personalization priors from fashion consultancy knowledge and expertise. According to the color season concept, each person has a color season (a set of hues and colors) that make their skin look more radiant, vibrant, and project the image of health. The user ranking unit 408 utilizes the color model to classify each individual into one of four color seasons: Winter, Spring, Summer, Autumn, based on, for example, the hair color, the eye color, the skin color of the user, and so on. For example, each color season defines a color palette including a set of colors containing a fine gradient of color tones for each one of the main forty (40) colors. For example, FIG. 10 illustrates an exemplary color palette 1000 for the winter color season including a set of twenty seven (27) colors 1002. For example, the set of colors 1002 included in the color palette 1000 for the winter color season may include bold and bright set of colors, such as, emerald-green, cobalt blue, holly berry red, and the like

In accordance with some embodiments, the four (4) color seasons may be further classified into twelve (12) sub-seasons based on the distribution of the color tones of the color palette based on warm or cool, light or deep, bright or muted color tones. For example, the user ranking unit 408 further classifies the color tones of the color palette as warm and cool colors to define the color sub-seasons. In an exemplary embodiment, the color palette determination unit 414 may be configured to employ the possible combinations of the fourteen (14) skin color, twelve (12) eye color, and eighteen (18) hair color instances to generate more than three thousand (3000) color palettes to accurately capture different color season and sub-season to cover a wide range of users with different body, facial, stylistic features. In accordance with various embodiments, by defining the sub-seasons and the color palettes for the sub-season, the best selection of colors based on the warm and the cool color tones of the user may be obtained from the color season palette.

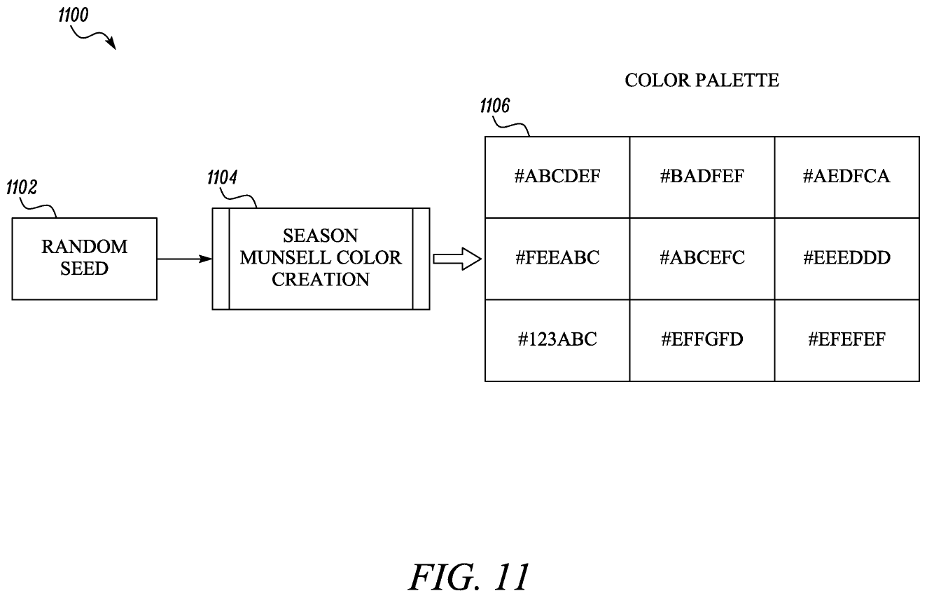

In some embodiments, the color palette determination unit 414 may be configured to determine the color season of the user based on a season Munsell color creation process 1100, as illustrated in FIG. 11. A random seed 1102 is input into the Season Munsell color creation process 1104 to determine the color palette corresponding to the color season of the user. It will be appreciated by those of ordinary skill in the art that the random seed 1102 is a number (or vector) used to initialize a pseudorandom number generator. Within the season Munsell color creation process 1104, a seasonal color analysis is performed to determine a user's color season. In some embodiments, the color season of the user may be determined, using other known techniques, based on the one or more user inputs corresponding to the hair color, the eye color, and the skin color provided by the user. Yet, in some other embodiments, the color season of the user may be determined based on the image of the user, for example, by extracting the average detected color of the hair color, the eye color, and the skin color of the user, using iris detection technique. The color palette determination unit 414 may be further configured to create colors that belong to each of the four seasons. For example, the color palette determination unit 414 may create colors 1106 that belong to the winter season. In accordance with various embodiments, the season Munsell color creation process is based on the Munsell theory to determine a large set of colors that are distributed equally in the hue domain to provide the user with the large set of color options in the garments. In some embodiments, the color palette determination unit 414 may be configured to periodically determine whether the one or more user inputs with regard to the hair color, the eye color, or the skin color of the user have changed and update the color season and/or the color palette of the user accordingly.

Referring back to FIG. 4, the style preference determination unit 416 is configured to receive the one or more user inputs in the form of user selection of one or more of the reference garment images representing various styles (interchangeably referred to as reference style images) and determine the preferred styles of the user based on the received one or more user inputs. As discussed before, the reference style images may be obtained from the internet sites or from various brands, and a vector representation of similarity for a plurality of classes may be performed to determine a style of each garment in the reference style image. The style preference determination unit 416 is configured to display the reference style images, receive a selection of one or more of the reference style images, and determine the styles of the one or more reference style images as the one or more preferred styles of the user based on the user selection. In some embodiments, the style preference determination unit 416 may be configured to determine the preferred style of the user based on the count of the one or more reference style images selected by the user for each style. In some embodiments, the preferred style may include a dominant style as well as one or more complementary styles of the user. For instance, based on the count of the one or more reference style images selected by the user for each style, the style preference determination unit 416 may be configured to determine that the style of the user is thirty percent (30%) boho, sixty percent (60%) casual, and ten percent (10%) chic. In this example, the casual style may be determined as the dominant style of the user, whereas the boho and chic styles may be determined as complementary styles of the user.

Further, the physical characteristics determination unit 418 may be configured to determine a body type of the user based on the received one or more user inputs associated with the height, weight, and the body dimensions of the user. The body type of the user may represent a body shape, such as, rectangle, hourglass, inverted triangle, oval and the like, and/or a clothing size, such as, petite, regular, plus size, or the like of the user. In accordance with some embodiments, the physical characteristics determination unit 418 is configured to determine the body type of the user based on the body measurements of the user, using various known body shape calculators.

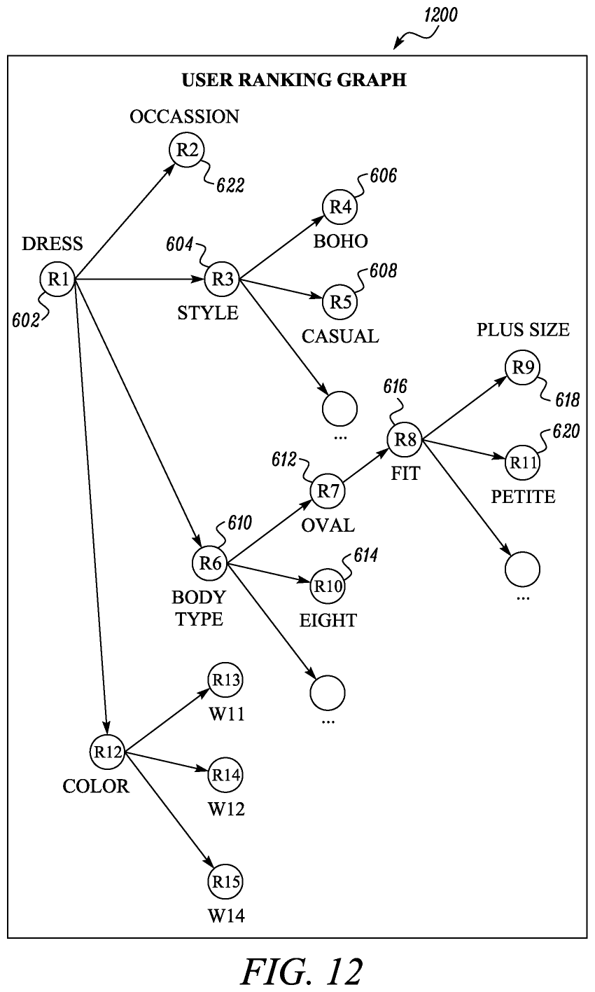

In an embodiment of the present disclosure, the user ranking unit 408 is further configured to assign weightages to each of the plurality of nodes (for example, the nodes 602, 604, 608, . . . and so on) defined in the taxonomy 600 based on the determined color palette, the one or more physical characteristics, and the one or more style preferences associated with the user to generate a user ranking graph specific to the individual user. For example, FIG. 12 illustrates an exemplary user ranking graph 1200 with weightages R1, R2, R3, . . . and so on, assigned to the plurality of nodes defined in the taxonomy 600 for a particular user. As will be understood by those ordinarily skilled, the user ranking unit 408 will generate a different user ranking graph for every user and accordingly, weightages assigned to every node in the taxonomy will be different for different users.

Further, the garment recommendation unit 412 is configured to generate, using a machine learning model, a recommended set of garment digital images to be displayed to the user, via the corresponding user device display 220, based on the user ranking graph and the assigned plurality of category labels associated with the garment digital images. The recommended set of garment digital images may include the garment digital images of the garments that are mostly likely to be suited for the user as per the preferences and details provided by the user. The garment recommendation unit 412 may be configured to generate the recommended set of garment digital images by applying the weightages assigned to the plurality of nodes in the user ranking graph to each garment in the garment digital images and accordingly provide the recommended set of garment digital images to the user. For instance, the garment recommendation unit 412 may be configured to generate the recommended set of garment digital images by applying the weightages assigned to the plurality of nodes in the user ranking graph to the assigned plurality of category labels of each of the garment digital images.

In accordance with various embodiments, the garment recommendation unit 412 is configured to generate the recommended set of garment digital images by determining, using the machine learning model, a recommendation score for each of the garment digital images based on the user ranking graph and the assigned plurality of category labels to the garment digital images. The garment recommendation unit 412 may be then configured to determine the recommended set of garment digital images based on the recommendation score for each of the garment digital images. For example, the garment recommendation unit 412 may be configured to include the garment digital images with the recommendation score greater than a threshold value in the recommended set of garment digital images. In some embodiments, the threshold value may be predefined and stored in the garment recommendation computing device data storage 316. The garment recommendation unit 412 may be then configured to rank each garment digital image in the recommended set based on the respective recommendation score.

In accordance with some embodiments, the garment recommendation unit 412 may be configured to determine a recommended score of each garment based on a color distance (also referred to as color distance rating/ranking) between each garment color of the one or more garment colors and the plurality of colors in the color palette associated with the user. The color distance may be defined as a distance between two colors in a color space. The garment recommendation unit 412 may be configured to determine, for each garment color, a color from the plurality of colors in the color palette with a minimum linear distance from the garment color and accordingly determine a recommendation score for each of the garment digital images based on the determined color and the determined minimum linear distance. In accordance with various embodiments, the garment recommendation unit 412 is configured to assign the recommendation score to the garment based on the proximity of the one or more garment colors to the colors in the color palette of the user. The system uses the color distance to sort the recommendation list. For example, the garment recommendation unit 412 may be configured to assign a higher recommendation score to a garment when the one or more garment colors are closer to the colors in the color palette of the user and a lower recommendation score when the one or more garment colors are farther from the colors in the color palette of the user. Since the color palette of the user is as per the season color of the user, the assignment of the recommendation score to the garments enables the garment recommendation computing device 104 to recommend garments with colors that improves the features and radiance of the skin of the user.

In accordance with some embodiments, the color distance rating requires a vast amount of colors to increase the accuracy of matching the garment colors with the colors in the color palette of the user. Therefore, the use of the Season Munsell color creation process 1104 (as explained above) to determine the color palette corresponding to the color season of the user ensures that the vast amount of colors are generated corresponding to the color season of the user.

In accordance with some embodiments, the garment recommendation unit 412 is configured to further determine a recommended score of each garment based on the determined body type of the user and the category label associated with the garment corresponding to the one or more body types of the garment. For example, the garment recommendation unit 412 is configured to provide a higher recommendation score to a garment when the category label associated with the garment corresponding to the one or more body types matches with the determined body type of the user. The assignment of the recommendation score based on the body type of the user enables the garment recommendation computing device 104 to recommend garments that matches the body type of the user and enhances the overall look of the user.

In accordance with some embodiments, the garment recommendation unit 412 is configured to determine a recommendation score of each garment based on the determined style preferences of the user and the category label associated with the garment corresponding to the styles of the garment. For instance, the garment recommendation unit 412 is configured to provide a higher recommendation score to the garment when the category label associated with the garment corresponding to the styles matches with the determined style preferences of the user. The assignment of the recommendation score based on the style preferences of the user enables the garment recommendation computing device 104 to recommend garments that match the dominant style or the one or more complementary styles of the user.

The garment recommendation computing device 104 is further configured to optimize a future garment recommendation list for each user based on an aggregation of the one or more user inputs received from an associated user device 102. For instance, the garment recommendation unit 412 is configured to determine an empirical consolidated recommendation score based on the individual recommended scores determined based on the color, the style, and the body shape associated with both the user and the garment. The garment recommendation unit 412 may be configured to apply the weightages assigned to the plurality of nodes in the user ranking graph to the corresponding category labels of each of the garment digital images and then determine the consolidated recommendation score based on the weighted recommendation scores. The consolidated recommendation score enables the garment recommendation unit 412 to determine the garments that may best match the user. Further, only the items that are suitable for their physical traits limited by a color distance threshold are recommended and displayed on the user device. The color distance threshold may be predefined and stored in the garment recommendation computing device data storage 316. In some embodiments, the garment recommendation unit 412 may be configured to utilize the machine learning model to determine the consolidated recommendation score based on preferences of the user and the behavioral data of users stored in the user profile.

The garment recommendation unit 412 is configured to display the recommended set of garment digital images for the user on the user device display 220 of the user device 102 associated with the user. The garment recommendation unit 412 is then configured to receive the user feedback, via the user device interface 204, on each of the garment digital images in the recommended set of garment digital images. Examples of the user feedback may include, but not limited to, liking, purchasing, and/or shortlisting of the garment and/or the garment digital images displayed to the user. In some embodiments, the garment recommendation unit 412 may be configured to display one garment digital image from the recommended set or a plurality of garment digital images from the recommended set to the user at a time. The garment recommendation unit 412 may be configured to receive the user feedback using, for example, the like or dislike icon, the right or left swipe, for each of the recommended set of garment digital images displayed on the user device 102 based on personal preferences of the user. In some embodiments, the user feedback may include the indication of the body parts that the user wishes to show off or conceal, using various selectable options such as, check boxes, drop-down menu lists, etc. For example, the user feedback may indicate that the user wishes to conceal body parts, such as, midsection, legs, cleavage, or the like.

In some embodiments, the garment recommendation unit 412 is further configured to determine accuracy and/or relevance of each garment digital image in the recommended set based on the determined recommendation score associated with the garment digital image. The determined accuracy and/or relevance of each garment digital image in the recommended set may then be displayed along with the garment digital image on the user device display 220. For example, the determined accuracy and/or relevance of each garment digital image in the recommended set may be displayed as a match percentage.

The garment recommendation unit 412 is further configured to continually update, using the machine learning model, the recommended set of garment digital images to be displayed based on the user feedback received for each of the displayed recommended set of garment digital images. Further, the user ranking unit 408 may be configured to update, using the machine learning model, the user ranking graph by reassigning weightages to one or more of the plurality of nodes in the user ranking graph based on the received user feedback. For instance, the user ranking unit 408 is further configured to assign more weightage to the nodes representing the category labels associated with the garment digital images liked or shortlisted or purchased by the user. The garment recommendation unit 412 may be further configured to determine the updated recommended set of garment digital images based on the updated user ranking graph, received from the user ranking unit 408, and the assigned plurality of category labels to the garments.

In accordance with some embodiments, the garment recommendation unit 412 is configured to generate and update the recommended set of garment digital images further based on one or more auxiliary factors including, but not limited to, one or more of current trends data, a current season data, a user price sensitivity data, a garment popularity data, a publication date data (recentness), a date of one or more user actions pre-recorded corresponding to a garment digital image, a user preference, the one or more inputs indicating the body parts that the user wishes to show off or conceal, sizes of garments pre-owned by the user, and user behavioral data. In some embodiments, data associated with the one or more auxiliary factors may be obtained from other devices and databases in the system 100 and stored in the garment recommendation computing device data storage 316. For example, the garment recommendation unit 412 is configured to generate and update the recommended set of garment digital images based on:
Current Trends or seasons: since garment catalogs provided by the one or more garment sources 108 may be updated regularly, mainly according to recent trends or season, and the like, it is important to increase the relevance of recently added garments, and alter the garments from an outdated season, and/or reduce their rank in the recommended list of garment digital images displayed to the user. To this end, the garment recommendation unit 412 may be configured to boost the recommendation score of the garments depending on the current trends, newness, and current season.
User price sensitivity: The garment recommendation unit 412 may be configured to update or refine the recommended list of garments based on a price range specified by the user.
Garment popularity: The garments displayed in the recommended list may be sorted to increase their rank based on the number of likes received for the garment and remove the disliked garments. For example, the garment recommendation unit 412 may be configured to multiply the recommendation score by a factor or add the like score directly to update the recommendation score of a garment. The garment recommendation unit 412 also uses popularity to penalize popular garments, using the inverse of the frequency.
Recentness: The garment recommendation unit 412 penalizes garments that the user liked or purchased a long time ago, the same for dislikes. To do so, it stores the timestamp of events to boost the score according to recentness. The scores are dynamic, in the sense that an item viewed a long time ago would be considered less relevant in the present than if it was liked three months ago.

In some embodiments, the garment recommendation unit 412 may be further configured to assign different hierarchy and importance scores to likes, dislikes, purchases, and shortlisted garments for generation and updation of the recommended set of garment digital images. In an alternative embodiment, the garment recommendation unit 412 may be configured to generate and update the recommended set of garment digital images further based on the user profile data. For example, the garment recommendation unit 412 uses a personalized ranking to show the recommended set, using the assumption that a high number of likes and purchases mean high engagement.

In some embodiments, the garment recommendation unit 412 may be further configured to determine a garment digital image in the recommended set that is liked by the user, when the user clicks the like option. Based on the liked garment digital image, the garment recommendation unit 412 may be further configured to identify one or more garment digital images similar to the liked garment digital image based on the category labels associated with the liked garment digital image. For example, the garment recommendation unit 412 may be configured to extract the category labels, such as, but not limited to, the color, the occasion, and the weather, associated with the liked garment digital image and then determine the one or more garment digital images having similar category labels. The garment recommendation unit 412 may be further configured to display the one or more garment digital images to the user as garments matching the liked garment digital image.

In accordance with some embodiments, the garment recommendation computing device 104 may be configured to implement a visual search engine. The visual search engine enables the garment recommendation computing device 104 to obtain one or more images of one or more garments from the user device 102 via the user device interface 204 and identify similar garments as in the obtained one or more images for providing recommendation to the user via the user device display 220. The obtained one or more images of one or more garments may include an image of the garments or an image of an individual wearing the one or more garments. In some embodiments, the garment categorization unit 410 of the garment recommendation computing device 104 may be configured to obtain the one or more images of the one or more garments from the user device 102 and determine, for each garment, a type of the garment such as, top, trousers, skirts, dress, and the like, using the image processing unit 406 as described above. The image processing unit 406 may be configured to determine the type of garment using the vector technique or other techniques known in the art. The image processing unit 406 may then be configured to extract and assign the category labels for each garment in the obtained one or more images using the image processing unit 406 using the vector techniques, as described above. In an exemplary embodiment, the category labels that are to be determined for a garment depends upon the type of the garment. For example, when the garment is a top, the category labels to be determined for the top may include the neckline type, the sleeve length, pattern and the like

The garment recommendation unit 412 of the garment recommendation computing device 104 may further be configured to generate the recommended set of garments based on the plurality of category labels extracted from the obtained one or more images. For example, the garment recommendation unit 412 may be configured to generate the recommended set of garments that includes the garment digital images with the category labels corresponding to the category labels extracted from the obtained one or more images provided by the user.

In accordance with some embodiments, the garment recommendation unit 412 is configured to recommend garment sizes to the user across various brands based on size of the garments owned by the user. The garment recommendation unit 412 may be configured to receive, from the user device 102 via the user device interface 204, the type of garments along with the brand and the corresponding sizes, such as small, medium, large, and the like, owned by the user. The garment recommendation unit 412 may then be configured to determine the size measurement information, such as waist size measurements, shoulder width measurements, length measurements and the like, corresponding the size and the brand of each garment entered by the user. For example, the garment recommendation unit 412 may be configured to determine the size measurement information from the size and the brand of each garment based on the garment recommendation data 320 stored in the garment recommendation computing device data storage 316. In some embodiments, the garment recommendation unit 412 may be configured to receive, from the user device 102 via the user device interface 204, the size measurement information, such as the waist size measurements, the shoulder width measurements, the length measurements and the like, associated with the user or with the garments owned by the user. The garment recommendation unit 412 may be further configured to recommend the garment size for the user for other brands based on the size measurement information. For example, the garment recommendation unit 412 may identify sizes across various brands for various types of garments corresponding to the determined size measurement information based on the garment recommendation data 320 stored in the garment recommendation computing device data storage 316. The garment recommendation unit 412 may be further configured to display the recommended sizes to the user via the user device display 220. As different brands follow different sizing standards, the translation of the sizes as mentioned above, enables the garment recommendation unit 412 to recommend the correct sizes to the user every time by relaying in the accuracy and veracity of sizing charts provided by the brands.

In accordance with some embodiments, the garment recommendation unit 412 may be configured to analyze the recommended set of garment digital images generated for each user and generate insight dashboards to understand the users in depth. In some embodiments, the generated insight dashboards may be provided to the one or more garment sources 108 to assist the one or more garment sources 108 to understand user demands. For example, the insights dashboard may empower the brands to get to know their customer deeply, so they can plan their offering based on the customer's real needs and preferences. In yet other embodiments, the generated insight dashboards may be utilized, by the garment recommendation unit 412, to deploy re-engagement emails and/or create editorial content focused on improving user experience with relevant recommendations. The re-engagement email may use a proprietary tool that enables the in-house stylists to create personalized content, uploading the content to the brand's site/marketplace or deploying the editorial content in the form of reengagement emails.

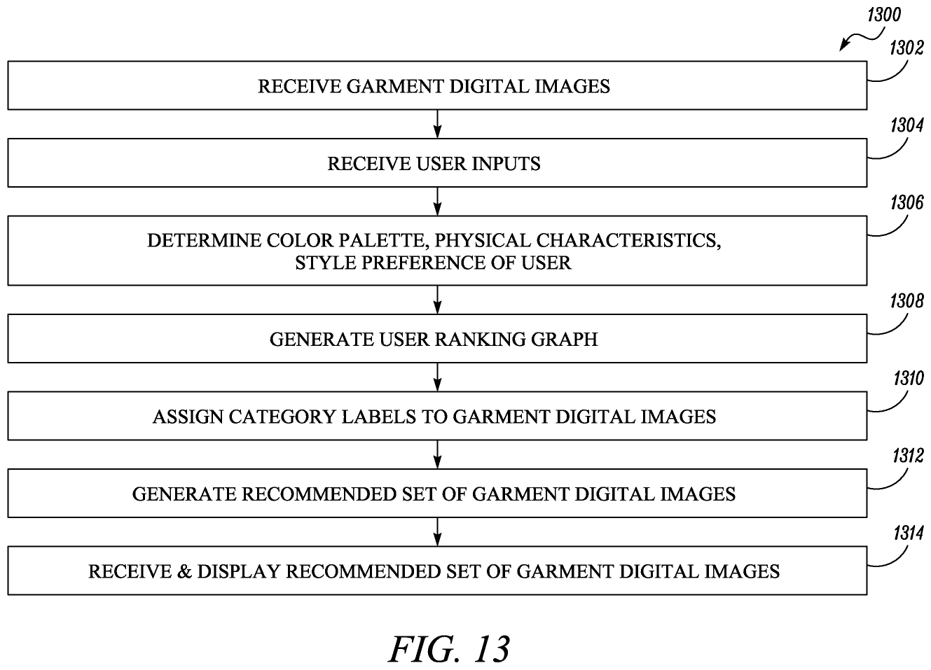

FIG. 13 illustrates a machine learning based garment recommendation method 1300 for displaying the recommended set of garment digital images to the user in accordance with some embodiments. In an exemplary implementation, the method 1300 may be performed by the garment recommendation computing device 104. Initially, at 1302, one or more garment digital images are received from the one or more garment sources 108, with each garment digital image having a garment associated with it, as described above.

Further, at 1304, one or more user inputs are received. For example, the user device display 220 of the user device 102 may be configured to receive the user inputs and provide them to the garment recommendation computing device 104. At 1306, the user ranking unit 408 of the garment recommendation computing device 104 determines the color palette, the one or more physical characteristics, and the one or more style preferences associated with the user based on the one or more user inputs.

At 1308, the user ranking unit 408 of the garment recommendation computing device 104 generates the user ranking graph having the plurality of nodes corresponding to the plurality of the predefined color palettes, the physical characteristics, and the style preferences. As described above, each of the plurality of nodes is assigned the weightage based on the determined color palette, the one or more physical characteristics, and the one or more style preferences associated with the user. In accordance with some embodiments, the user ranking unit 408 of the garment recommendation computing device 104 generates the user ranking graph by assigning the weightages to the plurality of nodes defined in the taxonomy, such as the taxonomy 600 described above.

In accordance with various embodiments, the taxonomy is generated by the taxonomy generation unit 404 based on the ontology, such as the ontology 500 described above. As described above, the ontology generation unit 402 of the garment recommendation computing device processor 308 generates the ontology based on the plurality of terms stored in the dictionary and the taxonomy generation unit 404 generates the taxonomy by classifying the plurality of terms in the generated ontology based on the characteristics of the plurality of terms.

Further, at 1310, the garment categorization unit 410 of the garment recommendation computing device 104 assigns the plurality of category labels to each garment digital image, such as by using the image processing unit 406. Each of the plurality of category labels corresponds to the one or more attributes associated with the garment in the garment digital image. The garment categorization unit 410 of the garment recommendation computing device 104 assigns the plurality of category labels to each garment digital image by segmenting the garment in the garment digital image to one or more garment segments and determining the one or more attributes associated with each of the one or more garment segments, using the image processing unit 406. The garment categorization unit 410 further determines the category label corresponding to a body type associated with the garment based on the determined one or more attributes.

In accordance with some embodiments, the garment categorization unit 410 of the garment recommendation computing device 104 further assigns the plurality of category labels to each garment digital image by processing the garment digital image to determine the style vector of the garment, using the image processing unit 406. The garment categorization unit 410 compares the style vector of the garment with the plurality of prestored style vectors corresponding to the plurality of predefined styles stored in the garment recommendation computing device memory 310 to determine the category label corresponding to the one or more styles associated with the garment based on the comparison of the style vector of the garment with the plurality of prestored style vectors.

Furthermore, at 1312, the garment recommendation unit 412 of the garment recommendation computing device 104 generates the recommended set of garment digital images to be displayed, using the machine learning model, based on the user ranking graph and the assigned plurality of category labels. In accordance with some embodiments, the garment recommendation unit 412 generates the recommended set of garment digital images by applying the weightages assigned to the plurality of nodes in the user ranking graph to the assigned plurality of category labels of each of the garment digital images.

In accordance with some embodiments, the garment recommendation unit 412 of the garment recommendation computing device 104 determines the recommendation score for each of the garment digital images. For example, the garment recommendation unit 412 determines the one or more garment colors in the garment digital image and then determines, for each garment color of the one or more garment colors, the color distance between the garment color and the plurality of colors in the color palette associated with the user. The garment recommendation unit 412 further determines the recommendation score for the corresponding garment digital image based on the color distance between each garment color of the one or more garment colors and the plurality of colors in the color palette associated with the user.

In accordance with various embodiments, the garment recommendation unit 412 generates the recommended set of garment digital images by determining the recommendation score for each of the garment digital images using the machine learning model based on the user ranking graph and the assigned plurality of category labels. The garment recommendation unit 412 then determines the recommended set of garment digital images based on the recommendation score for each of the garment digital images. For example, the recommended set includes the garment digital images with the recommendation score greater than the threshold value. The garment recommendation unit 412 further ranks each garment digital image in the recommended set based on the respective recommendation score.

In accordance with various embodiments, the garment recommendation unit 412 also generates and updates the recommended set of garment digital images further based on the one or more auxiliary factors selected from the group comprising the one or more current trends, the user price sensitivity, the garment popularity, the publication date, the date of one or more user actions pre-recorded corresponding to the garment digital image, the user preference, the one or more inputs indicating the body parts that the user wishes to show off or conceal, the sizes of the pre-owned garments, and the user behavioral data.

At 1314, the user device transceiver 202 of the at least one of the one or more user devices 102 receives the recommended set of garment digital images and the user device display 220 of the at least one of the one or more user devices 102 displays the recommended set of garment digital images.

In accordance with some embodiments, the garment recommendation unit 412 of the garment recommendation computing device 104 updates the recommended set of garment digital images to be displayed based on the user feedback received for each of the displayed recommended set of garment digital images using the machine learning model. Particularly, the garment recommendation unit 412 receives the user feedback from the at least one of the one or more user devices 102 for each of the recommended set of garment digital images displayed on the user device display 220 of the at least one of the one or more user devices 102. The user ranking unit 408 further updates the user ranking graph using the machine learning model by reassigning weightages to the one or more of the plurality of nodes in the user ranking graph based on the received user feedback. The garment recommendation unit 412 then determines the updated recommended set of garment digital images based on the updated user ranking graph and the assigned plurality of category labels. The user device transceiver 202 of the at least one of the one or more user devices 102 receives the updated recommended set of garment digital images and the user device display 220 of the at least one of the one or more user devices 102 displays the updated recommended set of garment digital images.

The embodiments described herein provides a recommended set of garment digital images that is personalized for each user. The recommendations are provided to the user by generating a user ranking graph for each user based on the physical characteristics, the style preferences, the color palette, and the like, of each user. The system and method described herein also consider other factors, such as, the user feedback on the recommended set of garments, the user behavior, the user profile and the like, to provide personalized results to each user. The use of machine learning to provide recommendations and to track the user feedback, increases the relevancy of the recommendations provided to the user with time. The system and method described herein utilize machine learning to track and consider more than one hundred and fifty (150) factors associated with the user and the garments to provide highly personalized recommendations to each user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A machine learning based garment recommendation system for displaying a recommended set of garment digital images to a user, the system comprising:
one or more garment sources for providing one or more garment digital images, each garment image having an associated garment;
one or more user devices comprising:
a user device transceiver for receiving communications,
a user device interface for receiving one or more user inputs, and
a user device display; and
a garment recommendation computing device operatively coupled to the one or more garment sources and to the one or more user devices, the garment recommendation computing device comprising:
a user ranking unit configured to:
determine a color palette, one or more physical characteristics, and one or more style preferences associated with the user based on the one or more user inputs, and
generate a user ranking graph comprising a plurality of nodes corresponding to a plurality of predefined color palettes, physical characteristics, and style preferences, wherein each of the plurality of nodes is assigned a weightage based on the determined color palette, the one or more physical characteristics, and the one or more style preferences associated with the user,
a garment categorization unit configured to:
assign, using an image processing unit, a plurality of category labels to each garment digital image, wherein each of the plurality of category labels corresponds to one or more attributes associated with a garment in the garment digital image, and
a garment recommendation unit configured to:
generate, using a machine learning model, the recommended set of garment digital images to be displayed, the recommended set being determined based on the user ranking graph and the assigned plurality of category labels,
wherein at least one of the one or more user devices is configured to receive from the garment recommendation computing device via the user device transceiver and display on the user device display the recommended set of garment digital images.

2. The machine learning based garment recommendation system according to claim 1, wherein the garment categorization unit is configured to assign the plurality of category labels to each of the garment digital images by:
segmenting, using the image processing unit, the garment in the garment digital image to one or more garment segments,
determining, using the image processing unit, the one or more attributes associated with each of the one or more garment segments, and
determining a category label corresponding to a body type associated with the garment based on the determined one or more attributes.

3. The machine learning based garment recommendation system according to claim 2, wherein the one or more attributes are selected from a group comprising one or more of a color, the body type, the style, a neckline type, a sleeve length, a sleeve type, a print pattern, embellishment details, and a fit associated with the garment.

4. The machine learning based garment recommendation system according to claim 1, wherein the garment recommendation computing device further comprises:
a garment recommendation computing device memory for storing a dictionary including a plurality of terms associated with garments, wherein the plurality of terms represent different aspects of a plurality of garments,
an ontology generation unit for generating an ontology based on the plurality of terms stored in the dictionary, wherein the generated ontology defines the plurality of terms and a relationship between the plurality of terms in a structured manner, and
a taxonomy generation unit for generating a taxonomy by classifying the plurality of terms in the generated ontology based on the characteristics of the plurality of terms, wherein the taxonomy includes the plurality of nodes representing the plurality of terms and the relationship between the plurality of nodes,
wherein the user ranking unit is configured to generate the user ranking graph by assigning the weightages to the plurality of nodes defined in the taxonomy.

5. The machine learning based garment recommendation system according to claim 1, further comprising:
a garment recommendation computing device memory for storing a plurality of prestored style vectors corresponding to a plurality of predefined styles,
wherein the garment categorization unit is configured to assign the plurality of category labels to each of the garment digital images by:
processing, using the image processing unit, the garment digital image to determine a style vector of the garment in the garment digital image, wherein the style vector represents a numeric score indicating one or more styles of the garment,
comparing the style vector of the garment with the plurality of prestored style vectors corresponding to the plurality of predefined styles, and
determining a category label corresponding to the one or more styles associated with the garment based on the comparison of the style vector of the garment with the plurality of prestored style vectors.

6. The machine learning based garment recommendation system according to claim 1, wherein the garment recommendation unit is further configured to determine a recommendation score for each of the garment digital images by:
determining one or more garment colors in the garment digital image,
determining, for each garment color of the one or more garment colors, a color distance between the garment color and a plurality of colors in the color palette associated with the user, and
determining the recommendation score for the corresponding garment digital image based on the color distance between each garment color of the one or more garment colors and the plurality of colors in the color palette associated with the user.

7. The machine learning based garment recommendation system according to claim 1, wherein the garment recommendation unit is further configured to:
update, using the machine learning model, the recommended set of garment digital images to be displayed based on a user feedback received for each of the displayed recommended set of garment digital images, wherein updating the recommended set comprises:
receiving, by the garment recommendation unit, the user feedback for each of the recommended set of garment digital images displayed on the user device display via the user device interface,
updating, by the user ranking unit, the user ranking graph by reassigning weightages to one or more of the plurality of nodes in the user ranking graph based on the received user feedback and using the machine learning model, and
determining, by the garment recommendation unit, the updated recommended set of garment digital images based on the updated user ranking graph and the assigned plurality of category labels,
wherein the at least one of the one or more user devices is configured to receive from the garment recommendation computing device via the user device transceiver and display on the user device display the updated recommended set of garment digital images.

8. The machine learning based garment recommendation system according to claim 1, wherein the garment recommendation unit is configured to generate the recommended set of garment digital images by:
determining, using the machine learning model, a recommendation score for each of the garment digital images based on the user ranking graph and the assigned plurality of category labels,
determining the recommended set of garment digital images based on the recommendation score for each of the garment digital images, wherein the recommended set includes the garment digital images with the recommendation score greater than a threshold value, and
ranking each garment digital image in the recommended set based on the respective recommendation score.

9. The machine learning based garment recommendation system according to claim 1, wherein the garment recommendation unit is configured to generate and update the recommended set of garment digital images further based on one or more auxiliary factors selected from a group comprising one or more current trends, a user price sensitivity, a garment popularity, a publication date, a date of one or more user actions pre-recorded corresponding to a garment digital image, a user preference, and a user behavioral data.

10. The machine learning based garment recommendation system according to claim 1, wherein generating the recommended set of garment digital images comprises applying the weightages assigned to the plurality of nodes in the user ranking graph to the assigned plurality of category labels of each of the garment digital images.

11. A machine learning based garment recommendation method for displaying a recommended set of garment digital images to a user in a system comprising one or more garment sources, one or more user devices, and a garment recommendation computing device, the method comprising:
receiving, from the one or more garment sources, one or more garment digital images, each garment digital image having an associated garment;
receiving, by a user device interface of at least one of the one or more user devices, one or more user inputs;
determining, by a user ranking unit of the garment recommendation computing device, a color palette, one or more physical characteristics, and one or more style preferences associated with the user based on the one or more user inputs;
generating, by the user ranking unit of the garment recommendation computing device, a user ranking graph comprising a plurality of nodes corresponding to a plurality of predefined color palettes, physical characteristics, and style preferences, wherein each of the plurality of nodes is assigned a weightage based on the determined color palette, the one or more physical characteristics, and the one or more style preferences associated with the user;
assigning, by a garment categorization unit of the garment recommendation computing device, a plurality of category labels to each garment digital image using an image processing unit, wherein each of the plurality of category labels corresponds to one or more attributes associated with a garment in the garment digital image;
generating, by a garment recommendation unit of the garment recommendation computing device, the recommended set of garment digital images to be displayed, the recommended set being determined using a machine learning model based on the user ranking graph and the assigned plurality of category labels; and
receiving via a user device transceiver of the at least one of the one or more user devices and displaying on a user device display of the at least one of the one or more user devices, the recommended set of garment digital images.

12. The machine learning based garment recommendation method according to claim 11, wherein the assigning of the plurality of category labels to each of the garment digital images by:
segmenting, by the garment categorization unit of the garment recommendation computing device, the garment in the garment digital image to one or more garment segments:
determining, by the garment categorization unit of the garment recommendation computing device, the one or more attributes associated with each of the one or more garment segments using the image processing unit; and
determining, by the garment categorization unit of the garment recommendation computing device, a category label corresponding to a body type associated with the garment based on the determined one or more attributes.

13. The machine learning based garment recommendation method according to claim 12, wherein the one or more attributes are selected from a group comprising one or more of a color, the body type, the style, a neckline type, a sleeve length, a sleeve type, a print pattern, embellishment details, and a fit associated with the garment.

14. The machine learning based garment recommendation method according to claim 11, further comprising:
storing, by a garment recommendation computing device memory of the garment recommendation computing device, a dictionary including a plurality of terms associated with garments, wherein the plurality of terms represent different aspects of a plurality of garments;
generating, by an ontology generation unit of the garment recommendation computing device, an ontology based on the plurality of terms stored in the dictionary, wherein the generated ontology defines the plurality of terms and a relationship between the plurality of terms in a structured manner; and
generating, by a taxonomy generation unit of the garment recommendation computing device, a taxonomy by classifying the plurality of terms in the generated ontology based on the characteristics of the plurality of terms, wherein the taxonomy includes the plurality of nodes representing the plurality of terms and the relationship between the plurality of nodes,
wherein generating the user ranking graph comprises assigning the weightages to the plurality of nodes defined in the taxonomy.

15. The machine learning based garment recommendation method according to claim 11, wherein assigning the plurality of category labels to each of the garment digital images comprises:
processing, by the garment categorization unit of the garment recommendation computing device, the garment digital image to determine a style vector of the garment in the garment digital image using the image processing unit, wherein the style vector represents a numeric score indicating one or more styles of the garment;
comparing, by the garment categorization unit of the garment recommendation computing device, the style vector of the garment with a plurality of prestored style vectors corresponding to a plurality of predefined styles stored in a garment recommendation computing device memory; and
determining, by the garment categorization unit of the garment recommendation computing device, a category label corresponding to one or more styles associated with the garment based on the comparison of the style vector of the garment with the plurality of prestored style vectors.

16. The machine learning based garment recommendation method according to claim 11, further comprising:
determining a recommendation score for each of the garment digital images, wherein the determining comprises:
determining, by the garment recommendation unit of the garment recommendation computing device, one or more garment colors in the garment digital image;
determining, by the garment recommendation unit of the garment recommendation computing device, for each garment color of the one or more garment colors, a color distance between the garment color and a plurality of colors in the color palette associated with the user; and
determining, by the garment recommendation unit of the garment recommendation computing device, the recommendation score for the corresponding garment digital image based on the color distance between each garment color of the one or more garment colors and the plurality of colors in the color palette associated with the user.

17. The machine learning based garment recommendation method according to claim 11, further comprising:
updating the recommended set of garment digital images to be displayed based on a user feedback received for each of the displayed recommended set of garment digital images using the machine learning model by:
receiving, by the garment recommendation unit of the garment recommendation computing device, the user feedback from the at least one of the one or more user devices for each of the recommended set of garment digital images displayed on the user device display of the at least one of the one or more user devices;
updating, by the user ranking unit of the garment recommendation computing device, the user ranking graph using the machine learning model by reassigning weightages to one or more of the plurality of nodes in the user ranking graph based on the received user feedback; and
determining, by the gal vent recommendation unit of the garment recommendation computing device, the updated recommended set of garment digital images based on the updated user ranking graph and the assigned plurality of category labels,
receiving via the user device transceiver of the at least one of the one or more user devices and displaying on the user device display of the at least one of the one or more user devices, the updated recommended set of garment digital images.

18. The machine learning based garment recommendation method according to claim 11, wherein generating the recommended set of garment digital images comprises:
determining, by the garment recommendation unit of the garment recommendation computing device, a recommendation score for each of the garment digital images using the machine learning model based on the user ranking graph and the assigned plurality of category labels;
determining, by the garment recommendation unit of the garment recommendation computing device, the recommended set of garment digital images based on the recommendation score for each of the garment digital images, wherein the recommended set includes the garment digital images with the recommendation score greater than a threshold value; and
ranking, by the garment recommendation unit of the garment recommendation computing device, each garment digital image in the recommended set based on the respective recommendation score.

19. The machine learning based garment recommendation method according to claim 11, further comprising:
generating and updating, by the garment recommendation unit of the garment recommendation computing device, the recommended set of garment digital images further based on one or more auxiliary factors selected from a group comprising one or more current trends, a user price sensitivity, a garment popularity, a publication date, a date of one or more user actions pre-recorded corresponding to a garment digital image, a user preference, and a user behavioral data.

20. The machine learning based garment recommendation method according to claim 11, wherein generating the recommended set of garment digital images comprises applying the weightages assigned to the plurality of nodes in the user ranking graph to the assigned plurality of category labels of each of the garment digital images.
